(19) United States
(12) Patent Application Publication
(10) Pub. No.: US 2026/0127024 A1
(43) Pub. Date: May 7, 2026

(54) DATA HANDLING

(71) Applicant: Arm Limited, Cambridge (GB)

(72) Inventors: Rune HOLM, Oslo (NO); Dominic Hugo SYMES, Cambridge (GB); Elliot Maurice Simon ROSEMARINE, London (GB)

(21) Appl. No.: 19/073,477

(22) Filed: Mar. 7, 2025

Related U.S. Application Data
(63) Continuation-in-part of application No. 18/939,277, filed on Nov. 6, 2024.

(51) Int. Cl. G06F 9/48

(52) U.S. Cl. CPC G06F 9/4856; G06F 9/4881

(57) ABSTRACT

An apparatus comprising storage, an execution unit and a handling unit. The handling unit is configured to obtain task data that describes a task to be executed. The task comprises a plurality of operations representable as a directed graph of operations. The task data comprises task-specific variable data representative of a task-specific variable for use in executing an operation of the plurality of operations. The handling unit is configured to obtain a data move instruction and, based on the data move instruction, move the task-specific variable data into a physical storage location of the storage. The handling unit is configured to dispatch invocation data, based on the task data and the physical storage location, to the execution unit to cause the execution unit to execute the operation.

### CROSS-REFERENCE TO RELATED APPLICATIONS

This application is a continuation-in-part under 35 U.S.C. § 120 of U.S. application Ser. No. 18/939,277, filed Nov. 6, 2024. Each of the above-referenced patent applications is incorporated by reference in its entirety.

### BACKGROUND

### Technical Field

The disclosure herein relates to apparatuses and methods for use in executing an operation, such as a data processing operation.

### Description of the Related Technology

Certain data processing techniques, such as neural network processing and graphics processing, involve the processing and generation of considerable amounts of data using operations. It is desirable to handle data such as this in an efficient and/or flexible manner.

### SUMMARY

According to a first aspect of the present disclosure, there is provided an apparatus comprising storage, an execution unit and a handling unit, wherein the handling unit is configured to: obtain task data that describes a task to be executed, the task comprising a plurality of operations representable as a directed graph of operations, the task data comprising task-specific variable data representative of a task-specific variable for use in executing an operation of the plurality of operations; obtain a data move instruction; based on the data move instruction, move the task-specific variable data into a physical storage location of the storage; and dispatch invocation data, based on the task data and the physical storage location, to the execution unit to cause the execution unit to execute the operation.

According to a second aspect of the present disclosure, there is provided a method comprising: obtaining, by handling circuitry, task data that describes a task to be executed, the task comprising a plurality of operations representable as a directed graph of operations, the task data comprising task-specific variable data representative of a task-specific variable for use in executing an operation of the plurality of operations; obtaining, by the handling circuitry, a data move instruction; based on the data move instruction, the handling circuitry moving the task-specific variable data into a physical storage location of storage accessible to the handling circuitry; and dispatching, by the handling circuitry, invocation data, based on the task data and the physical storage location, to execution circuitry for execution of the operation.

### BRIEF DESCRIPTION OF THE DRAWINGS

FIG. 1 is a flow diagram of a method of moving data based on a data move instruction according to an example;

FIG. 2 is a schematic representation of an example apparatus;

FIG. 3 illustrates an example directed graph;

FIG. 4 is a schematic diagram of a data processing system;

FIG. 5 is a schematic diagram of an example neural engine;

FIG. 6 is a schematic diagram of an example system for allocating handling data;

FIG. 7 is a schematic diagram of a data processing apparatus including a central processing unit (CPU) and a hardware accelerator;

FIG. 8 is a schematic diagram of a data structure for storing an instruction;

FIG. 9 is a schematic representation of a simulator implementation according to an example; and

FIG. 10 is a schematic diagram of manufacture of a system and a chip-containing product.

### DETAILED DESCRIPTION

### Data Move Instruction

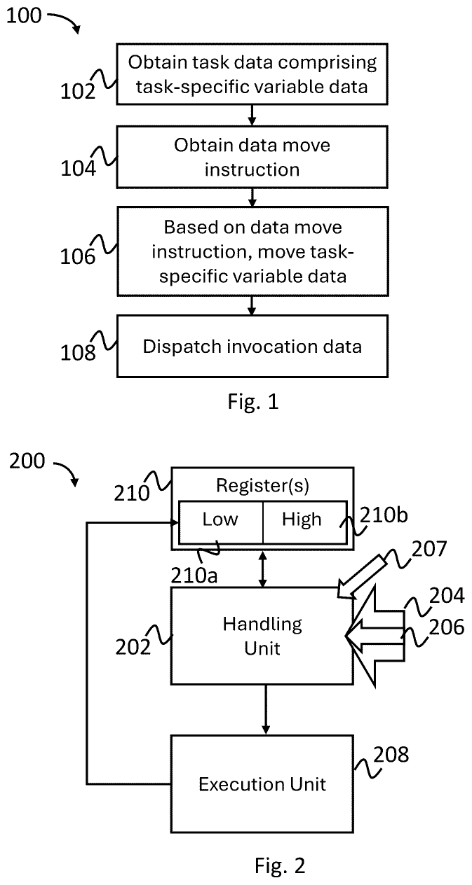

FIG. 1 is a flow diagram 100 showing a method of moving data based on a data move instruction. The method may be performed by a handling unit of an apparatus comprising storage and an execution unit. The handling unit may be implemented by handling circuitry so that the method is executed by the handling circuitry. The execution unit may be implemented by execution circuitry, which may be considered to be an example of processing circuitry.

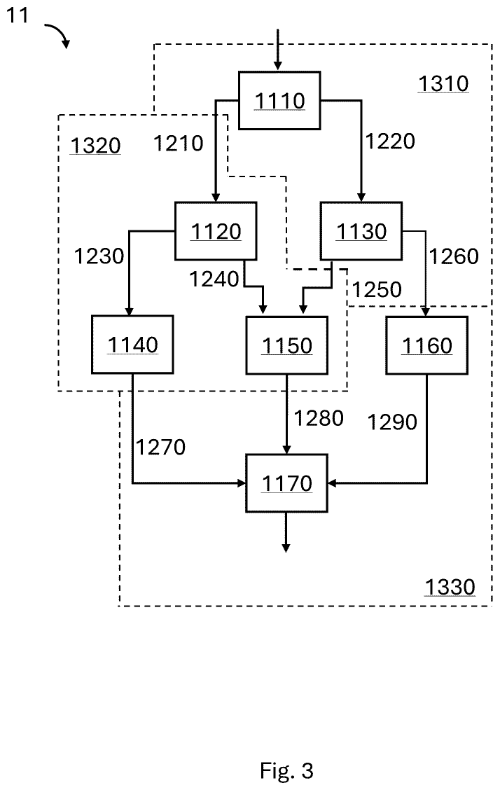

At item 102 of the flow diagram 100, task data that represents a task to be executed is obtained. The task comprises a plurality of operations representable as a directed graph of operations, as explained further with reference to FIG. 3. The task data comprises task-specific variable data representative of a task-specific variable for use in executing an operation of the plurality of operations, for example by processing circuitry such as the execution circuitry implementing the execution unit. The task-specific variable is for example a number or bit pattern, which may be a constant, which can be used for various purposes to execute a variety of different types of operation.

At item 104, a data move instruction is obtained. At item 106, the task-specific variable is moved into a physical storage location of the storage of the apparatus, based on the data move instruction. At item 108, invocation data, based on the task data and the physical storage location, is dispatched to the execution unit to cause the execution unit to execute the operation. The invocation data for example includes, or otherwise indicates, the data that is to be processed in executing the operation (which for example includes the task-specific variable data and input data to be processed with the task-specific variable, e.g. representing at least one portion of a multi-dimensional tensor). For example, the invocation data may include the task-specific variable data itself or a pointer to the physical storage location storing the task-specific variable data to allow the task-specific variable data to be obtained from the physical storage location by the execution unit.

Methods in accordance with the flow diagram 100 of FIG. 1 for example provide a computationally efficient way to enable flexibility in operations to be executed. Moving the task-specific variable data to the physical storage location and generating the invocation data based on the physical storage location for example allows the task-specific variable to be passed flexibly and straightforwardly to the execution unit to execute the operation.

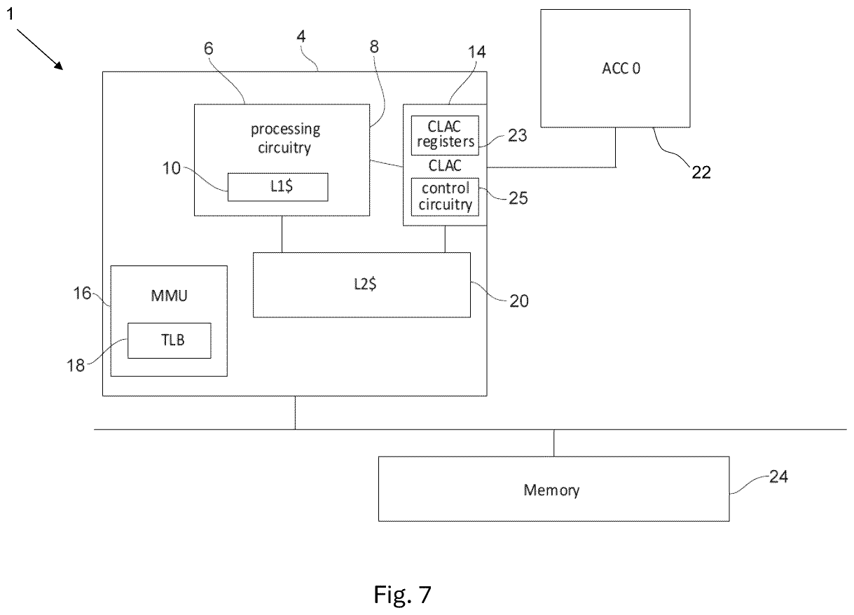

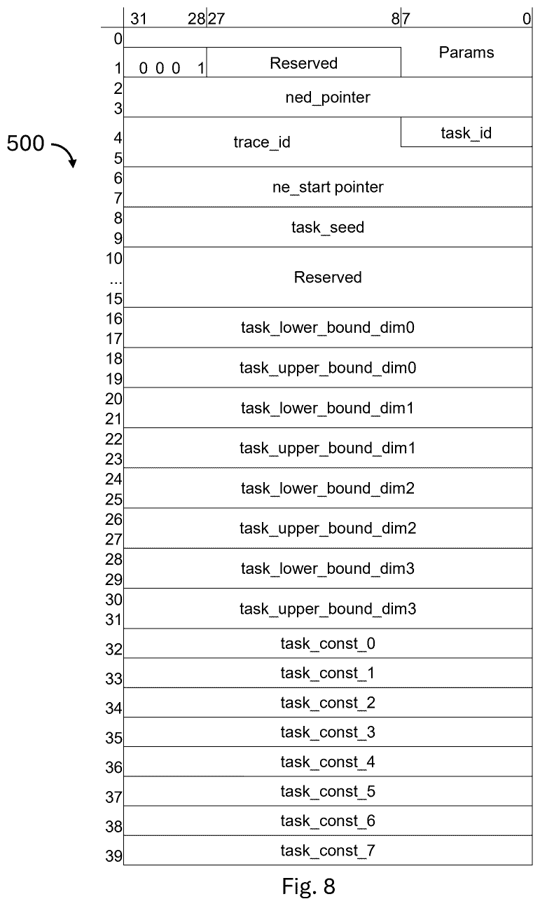

For example, the task data may comprise compiled task data compiled prior to setting a value of the task-specific variable. If the task is a neural network processing task, which can be implemented using a hardware accelerator such as a neural engine (described further below with reference to FIG. 5), the compiled task data may represent a (compiled) neural engine program descriptor (“NED”), which defines the task to be executed. However, the value of the task-specific variable may not be known at a time of compiling the task data, e.g. by a compiler of or coupled to the apparatus. Once the task-specific variable is set to a particular value, e.g. after compiling the task data, the task-specific variable data representing the task-specific variable with the particular value can be passed to the handling unit as part of an instruction for configuring the apparatus to perform the task (discussed further with reference to FIGS. 7 and 8 below). For example, the instruction to configure the apparatus to perform the task may comprise a field comprising a pointer to the compiled NED as well as a task-specific variable field comprising the task-specific variable data. In this way, the task-specific variable can be provided to the execution unit without recompiling the task data (e.g. the NED). Similarly, the value of the task-specific variable can be changed by changing the task-specific variable data stored in the physical storage location, without recompiling the task data. This can reduce power consumption and increase computational efficiency compared to recompiling the task data in order to update a value of the task-specific variable.

FIG. 2 is a schematic representation of an apparatus 200 for performing a data move instruction, for example as described above in relation to the flow diagram 100 of FIG. 1. The apparatus 200 comprises a handling unit 202 configured to obtain task data 204 and a data move instruction 207. The task data 204 comprises task-specific data 206. The apparatus 200 further comprises an execution unit 208 and register(s) 210. The apparatus 200 may also comprise storage (not shown), e.g. a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc. In some examples, the register 210 may form part of this storage medium.

The task data 204 is indicative of a task to be executed. As explained with reference to FIG. 1, the task comprises operations representable as a directed graph of operations. In this example, the task data 204 defines a multi-dimensional nested loop defining an operation space. The handling unit 202 is configured to iterate over the operation space in blocks. Respective blocks in the operation space may be referred to herein as operation blocks. The execution unit 208 is configured, by invocation data sent by the handling unit 202, to execute at least an operation of the operations. The operation uses the task-specific variable data 206 of the task data 204, and for example comprises processing of input data with the task-specific variable data 206.

The handling circuitry 202 may be configured to receive various other data and/or instructions in addition to the task data 204 and the data move instruction 207. Similarly, the processing circuitry 208 may be configured to perform any number of tasks, and in particular, is configured to move the task-specific variable data 206 in accordance with the data move instruction 207.

In FIG. 2, the operation space is defined by data stored in the registers 210, which in this example are boundary registers. The registers 210 comprise a respective register for each dimension of the multi-dimensional nested loop. For a particular block in the operation space, each register 210 comprises a low portion 210a for storing a low bound of the block for the corresponding dimension, and a high portion 210b for storing a high bound of the block for that dimension. The low and high portions 210a, 210b may be referred to herein as low and high bound fields, respectively. The values stored in the low and high portions 210a, 210b of the register 210 for a given dimension thus define a range of the block in that dimension. Hence, the register 210 for a given dimension may be considered to store range data defining the range of a block in the given dimension.

The data move instruction 207 instructs movement of the task-specific variable data 206 of the task data 204 into a physical storage location. The physical storage location to which the task-specific variable data 206 is moved, based on the data move instruction, may comprise at least a field of a particular boundary register of the boundary registers, such as at least one of the low or high portion 210a, 210b of the particular boundary register.

In the example of FIG. 2, the data move instruction 207 can be expressed using the following pseudo-code:

```
execute(ne_task_state_t &task, bound_t b[12], uint4_t &dst, bound_t
&acc, bool &end_flag){
    if (L) {
    b[dst].lo = task.task_const[src1];
  }
  else {
    b[dst].lo = 0;
    b[dst].hi = task.task_const[src1];
  }
  if (D) {
    dst = (dst + 1) % 12;
  }
}
```

where task represents the task data 204, b represents the set of boundary registers 210, each storing a low and high bound for a respective dimension of a multi-dimensional nested loop, dst is the current destination register of the set of boundary registers 210 (which is the register to which the task-specific variable data 206 is to be moved), and task.task_const/src1/represents the task-specific variable data 206. In this example, there are 12 boundary registers 210 but in other examples there may be more or fewer boundary registers than 12. A value of L (which may be referred to as a boundary register modifier) indicates how the low and high portions 210a, 210b of the destination register are to be updated based on the task-specific variable data 206. If L has a first predefined value (e.g. with a value of 0 or a NULL value, for example so that L is not set), then the current destination boundary register is set to the range: [0, task.task_const [src1]]. In other words, if/has the first predefined value, the task-specific variable data 206 is moved to the high portion 210b and a predetermined value of 0 is stored in the low portion 210a. Conversely, if L has a second predefined value (e.g. with a non-zero value), then the task-specific variable data 206 is moved to the low portion 210a of the current destination boundary register and the high portion 210b of the current destination boundary register is unchanged. In other words, the handling unit 202 can, in dependence on the boundary register modifier (e.g. whether L has the first or second predefined value) associated with the data move instruction 207, set a particular low bound field of a particular boundary register (in this case, the low portion 210a of the current destination boundary register) to a particular value (e.g. 0) and move the task-specific variable data 206 to a particular high bound field of the particular boundary register (in this case, the high portion 210b of the current destination boundary register) and/or move the task-specific variable data 206 to the particular low bound field. Performing the data move instruction 207 with the value of/set to the first predefined value and subsequently performing the data move instruction 207 with the value of L set to the second predefined value can be used to move task-specific data 206 to the high portion 210b and then the low portion 210a. This data move instruction 207 therefore allows the task-specific variable data 206 to be moved to the low and/or high portions 210a, 210b of a given boundary register 210 in a flexible manner.

The current destination boundary register to which the task-specific variable data 206 is moved based on the data move instruction 207 may be a predefined boundary register, such as a boundary register that is anticipated to be unused at a time of moving the task-specific variable data 206. The data move instruction 207 may be performed while the handling unit 202 iterates over a particular dimension of the multi-dimensional nested loop, in which case the current destination boundary register may be the boundary register associated with that particular dimension, or a boundary register defined relative to that particular dimension (such as for a dimension n dimension(s) inward or outward of the particular dimension within the nested loop, where n is an integer).

After the task-specific variable data 206 is moved to a given portion of a boundary register 210, the handling unit 202 sends invocation data to the execution unit 208 based on the task data 204 and the physical storage location (which in this case is the low and/or high portion 210a, 210b of the boundary register 210 to which the task-specific variable data 206 was moved). The handling unit 202 may retrieve the task-specific variable data 206 from the boundary register 210 to which it was moved and send the task-specific variable data 206 to the execution unit 208 as part of the invocation data. Additionally or alternatively, the handling unit 202 may send, to the execution unit 208, a pointer to the physical storage location as part of the invocation data, to allow the execution unit 208 to obtain the task-specific variable data 206 from the physical storage location indicated by the pointer.

The execution unit 208 uses the task-specific variable data 206 to execute the operation. Various different operations may use task-specific variable data 206 moved in accordance with the data move instruction 207, as will now be explained.

### Example Uses of Task-Specific Variable Data

In examples like that of FIG. 2, in which the handling unit 202 iterates over a multi-dimensional operation space in blocks, the handling unit 202 may be configured to set a value of the task-specific variable data 206 on a per-block basis for at least a plurality of the blocks. This can provide greater flexibility than using task-specific variable data 206 with a fixed value that does not differ for different blocks.

Setting the value of the task-specific variable data 206 on a per-block basis can be used to dynamically alter the range, shape and/or size of blocks to be processed in executing the task. The same task data 204, e.g. in the form of a NED, can be used to define each of the blocks in the operation space, initially. However, the definition of each block can then be adjusted on a block-by-block basis, using the task-specific variable data 206. This may be used to define a set of blocks of different respective shapes and/or sizes than each other. For example, the task-specific variable data 206 can be used to define low and high bounds of each of the blocks in one or more of the dimensions, e.g. represented as a different respective adjustment to a reference low and high bound of a reference block in the one or more dimensions, as defined by the task data 204, in an adaptable way.

In some of these examples, the handling unit 202 is configured to use the task-specific variable data 206 to adjust the range of a given block in at least one dimension by modifying the range data stored in the boundary register(s) 210 for the given block, which define the range of the given block. For example, the handling unit 202 can retrieve the task-specific variable data 206 from the portion of the boundary register 210 in which it is stored (which is a boundary register 210 unused for defining the range of the given block) and then use the task-specific variable represented by the task-specific variable data 206 to adjust the values of the low and/or high bounds of the given block in at least one dimension, thereby modifying the range data representing the given block. For example, for each of at least one dimension of the given block, the handling unit 202 may add or subtract a value of the task-specific variable (or a multiple thereof) to or from a value of a low and/or high bound of the given block, or may otherwise perform a numerical function of the value of the task-specific variable and the value of the low and/or high bound of the given block, such as a multiplication, division and so forth. In this way, the handling unit 202 can add an offset or a scaled offset (such as an offset multiplied by a stride) to the given block and/or translate and/or scale the given block.

In examples such as that of FIG. 2, the handling unit 202 is configured to perform a procedure to map each block of the plurality of blocks that are iterated over in the operation space to a different respective local block in an operation-specific local space (which is for example a space that is specific to the operation that is to be performed, and may be referred to as a local space). This procedure may be referred to as a mapping procedure, and in this example comprises updating data stored in at least one of the registers 210 to store transformed data in at least one of the boundary registers 210. The transformed data defines a local block to which a particular (operation) block is mapped.

For example, a range of a boundary register for dimension d may be represented by a low (b[d].lo) and a high (b[d].hi) signed component of the boundary register. In other words, the low and high portions 210a, 210b of each of the registers 210 of FIG. 2 may store the b[d].lo and b[d].hi values, respectively, for the corresponding dimension, d, in the operation space, prior to performing the mapping procedure. Upon executing the mapping procedure, the low and high bounds of the outer dimension (i.e. the b[d].lo and b[d].hi values) may be updated for at least one of the dimensions.

The local block in the local space may be lower dimensional than the block in the operation space. In FIG. 2, the local block comprises dimensions 0 to (n-1), but there are m registers in total (for dimensions 0 to (m-1) of the block in the operation space, where m is greater than n). This means that, after executing the mapping procedure, registers n to (m-1) are unused in defining the local block. The data move instruction 207 may instruct the movement of the task-specific variable data 206 to an unused register 210.

Range data defining a particular block, which may be modified using the task-specific variable data 206, may define the block in the operation space or in the operation-specific local space. For example, the handling unit 202 may map respective blocks in the operation space to different local blocks in the operation-specific local space, based on the task-specific variable data 206, e.g. by mapping a given block from the operation space to the local space and then modifying the range of the given block in the local space, using the task-specific variable data 206, or by modifying the range of the given block in the operation space using the task-specific variable data 206 and then mapping the (modified) given block from the operation space to the local space.

In examples, after moving the task-specific variable data 206 into the physical storage location (e.g. a portion of a register 210), the handling unit 202 is configured to modify the task-specific variable data 206 stored in the physical storage location based on the task data 204, to facilitate use of different values of the task-specific variable data 206 for different respective portions of the task represented by the task data 204. For example, the task-specific variable data 206 may be modified for different respective blocks (defined based on the task data 204) by modifying the task-specific variable data 206 stored in the physical storage location.

In an example, the operation performed by the execution unit 208 comprises processing of an input feature map, for example represented by a tensor, and the task-specific variable is used in applying a padding to at least a portion of the input feature map in executing the operation. If a kernel is convolved with an input feature map without padding, the output feature map will be smaller than the input feature, which can result in losing information at the edges of the input feature map. To avoid this, padding may be applied to a block of an input feature map to which a convolution is to be applied so as to preserve the size of an output block of the output feature map.

The size of the input feature map (and/or the block of the input feature map) may not be known when the compiled task data is generated. However, a size and/or number of padding elements for use in the padding may be determined based on the task-specific variable data 206. For example, the size and/or number of padding elements may be variable to allow the size of a given block to be clipped to a particular size represented by, or otherwise determined using, the task-specific variable. This enables block sizes to be adapted to an input feature map whose size may not be known at compile time, e.g. without recompiling the task data.

Additionally or alternatively, applying the padding in examples comprises adding row(s) and/or column(s) of elements with values based on the task-specific variable around the border of the block of the input feature map to increase the spatial size of the block. This for example allows padding values (to be used as values for respective elements of newly added row(s) and/or column(s)) sent to the execution unit to be derived from the task-specific variable data 206, e.g. as moved to a physical storage location, such as at least a portion of a boundary register, based on the data move instruction.

The handling unit 202 may, for example, obtain the task-specific variable data 206 and move the task-specific variable data 206 to a physical storage location (such as an otherwise unused boundary register 210) based on the data move instruction. The task-specific variable data 206 in this case, represents a value to used for padding, such as a value to be used for each of the elements for the new row(s) and/or column(s) to be added to an outside of the block to pad the block. The value of the task-specific variable itself may be used as the value for the padding. Alternatively, the task-specific variable data 206 may be moved to the physical storage location and then modified by the handling unit 202 on a per-block basis so as to obtain an appropriate value for the padding for each block.

In examples, the task-specific variable data 206 stored in the physical storage location (or a pointer thereto), and representing a padding value, may be sent to the execution unit as part of the invocation data. The task-specific variable data 206 may be used by the execution unit for padding. For example, if, in executing a particular operation such as a convolution, the execution unit attempts to access out-of-bounds data, such as an out-of-bounds region of a tensor, the execution unit can fill the out-of-bounds region with the padding value represented by the task-specific variable data 206.

Further examples of ways in which the task-specific variable data 206 can be used will now be described.

### Convolution Operation

In an example, the task-specific variable data 206 is used in the execution of a 2D convolution operation, which can be expressed as a multi-dimensional loop of scalar operations. These may need to be executed on 2D input data (e.g. in the form of a tensor) having dimensions input X (IX) and input Y (IY):
(input) Input channel (IC)—a dimension representing the input channels upon which the operation is to be performed (in the example of images this may be three channels each representing one of red, green, and blue input channels)
(input) Kernel dimension X (KX)—a first dimension X of a 2D kernel;
(input) Kernel dimension Y (KY)—a second dimension Y of a 2D kernel;
(output) Output X (OX)—a first dimension of an output feature map for the convolution operation;
(output) Output Y (OY)—a second dimension of the output feature map for the convolution operation;
(output) Batch (N)—a batch dimension of the operation, where the operation is to be batched;
(output) Output channel (OC)—a dimension representing the output channels to be produced for the 2D convolution operation.

In one proposed ordering, KY/KX can be considered the inner-most dimensions and OC is the outer-most dimension.

For this 2D convolution operation, it is possible to express the operation to be performed as a “nested for-loop” of scalar operations as is illustrated in the pseudo-code set out below. In practice, when executing this operation, it is necessary for a processor to execute the operation across each of these dimensions by performing a multiple-accumulate operation (MAC), the result of which is then written into an accumulator (e.g. an accumulator buffer in hardware). Having operated through all of these dimensions, the 2D convolution is completed and the contents of the accumulator therefore represents the result of the 2D convolution operation across the entire dimensionality of operation.

```
for(output channel)
  for(batch N)
    for(output Y)
      for(output X)
        for(input channel)
          for(kernel Y)
            for(kernel X)
              MAC
              write accumulator
```

The seven dimensions of the convolution operation can collectively be used to define the ‘operation space’ in which the 2D convolution operation is to be performed. More specifically, the sizes of each dimension can be used to define an effective “bounding box” defining the size, the number of elements in each dimension, of the operation space upon which the operation is to be performed. To illustrate this in more detail, consider an example where a 3×3 (i.e. KX=3; KY=3) convolution operation having padding is to be performed on input data having dimension IX=15; IY=15; N=1; and IC=32. This operation results in the following minimum and maximum index values representing the upper and lower bounds inclusive (i.e. the size) of the dimensionality of the convolution operation as shown in Table 1:

TABLE 1

| | OC | N | OY | OX | IC | KY | KX |
|---|---|---|---|---|---|---|---|
| Min | 0 | 0 | 0 | 0 | 0 | 0 | 0 |
| Max | 63 | 0 | 14 | 14 | 31 | 2 | 2 |

The output of the 2D convolution operation would have dimensions N=1; OY=15; OX=15; OC=64. These values represent the size of the output of the 2D convolution operation but they do not alone wholly represent the size of the operation required to generate that output. To wholly represent the operation space of the operation, all of the dimensions of the operation are required as shown in the above table. A shorthand representation for the dimensions of the 2D convolution operation is [OC N OY OX IC KY KX] and in this specific example can be presented as the minimum and maximum index values as illustrated in the example above i.e. [64 1 15 15 32 3 3].

Operations such as this 2D convolution operation can be separated into operation blocks, each operation block representing a subset of an operation in which each dimension of the operation block covers a subset of the full range of the corresponding dimension in the operation. For example, the 2D convolution above can be separated into multiple operation blocks by breaking up the operation in the OY, OX, and IC dimensions. With an operation separated into operation blocks, each operation block remains at the same dimension as prior to the separation. For example, breaking up the operation in the OY dimension results in multiple operation blocks in the OY dimension. Breaking the operation into blocks involves separating the operation space of the operation into multiple blocks which each individually represent a portion of the operation but collectively represent the operation space. This block generation involves separating the operation space into blocks representing a non-overlapping subset of the dimensions in the operation space which wholly cover the operation space dimensions (e.g. the set of nested for-loops shown above). In an example where the operation is to be separated into a number of blocks, the operation space is broken down into blocks based upon a predetermined block size which defines for each dimension of the operation a fixed size. This fixed size block may be referred to herein as a block quantum.

As explained above, the blocks in the operation space can then be mapped to an operation-specific local space iteratively. Boundary registers 210, which can be used by the handling unit 202 as working registers, can be used to store range data defining each local block. For the 2D convolution with 7 dimensions, 7 boundary registers (e.g. labelled as boundary registers 0 to 6, b[0] to b[6], respectively) can be used to store the range data defining the convolution operation for the current local block. In an example, there are 9 boundary registers in total, meaning that 2 boundary registers (e.g. labelled as boundary registers 7 and 8, b[7] and b[8], respectively) are unused in defining the convolution operation. These unused boundary registers (e.g. corresponding to bounding boxes for unused dimensions 7 and 8) can be used to store task-specific variable data 206, which for example represents a parameter value. For example, different respective sets of task-specific variable data 206 may be moved into the low portions 210a of boundary registers 7 and 8 according to the data move instruction 207 (although in other examples, task-specific variable data 206 may be moved to a single boundary register, or more than two boundary registers, and/or set(s) of task-specific variable data 206 may instead be moved into the high portions 210b of the boundary registers 7 and 8). For example, task-specific variable data 206 may represent one or a plurality of task-specific variables, each of which may be moved into a different respective physical storage location based on the data move instruction.

In this example, the parameter values are treated as a constant for executing the convolution operation on the current local block rather than a dimension to be iterated over in executing the convolution operation. For example, boundary registers 7 and 8 may be used to store task-specific variable data 206 representing an input height and an input width, respectively. The input height and width represent the full input tensor size in height and width dimensions (e.g. y and x dimensions, respectively) after an upscaling process has been performed. These values may not be known at a time of compiling the NED (e.g. represented by compiled task data), so may instead be provided to the handling unit 202 as the task-specific variable data 206 separately from the compiled task data, e.g. as part of an instruction to configure the execution of the convolution operation. The input height and width are treated as a constraint for execution of the block. In an example, input data representing element(s) of the block that are outside the specified input height and width is treated as having a predetermined value, such as a value of zero. Alternatively, the task-specific variable data 206 received by the handling may be used to calculate the input height and width. In this case, the task-specific variable data 206 may represent at least one field of the task data 204, from which the input height and weight (and, in some cases, a value of at least one further field of the task data 204) can be calculated.

In this example, task-specific variable data 206 representing the input height and the input width is received by the handling unit 202, for example as part of the instruction to configure the execution of the convolution, and is moved to the boundary registers 7 and 8 by the handling unit 202 in response to executing the data move instruction. The input height and the input width are moved to the low portions 210a of boundary registers 7 and 8, respectively, in this example, but may be moved to other physical storage location(s) (such as a high portion of a respective boundary register) in other examples. The handling unit 202 then sends invocation data to the execution unit 208, which in this example is a convolution engine. The invocation data includes the input height and input width obtained from the low portions 210a of the boundary registers 7 and 8, which are used by the convolution engine to execute the 2D convolution (although in other cases, the invocation data may instead or additionally include a reference to the physical storage location in which the task-specific variable data 206 is stored).

### Multi-Core Operation

In an example, the task-specific variable data 206 is used to execute a job using a plurality of cores. This may enable parallelization of processing, allowing the job to be executed more efficiently. For example, a job comprising the processing of a multi-dimensional tensor may be split into a plurality of different tasks, each corresponding to the processing of a different respective portion of the tensor. Each task may be executed using a different core of a multi-core processor. For example, an apparatus may comprise a core for executing a task of the job, and a further core for executing a further task of the job (although it is to be appreciated that an apparatus may comprise more than two cores, and a job may be split into more than two tasks). The core and the further core may each comprise a respective handling unit, storage and execution unit (which may be referred to as a further handling unit, further storage and further execution unit for the further core, to distinguish from the handling unit, storage and execution unit of the core). The further handling unit, further storage and further execution unit may be the same as the handling unit 202, storage (e.g. boundary registers 210) and execution unit 208 of the core, but configured to execute a different task than that executed on the core.

In this example, the data move instruction is used to pass different task-specific variable data to different respective cores so that each core can execute a different respective task of the job (such as applying an operation to different respective portions of a tensor, stored in different respective regions of memory), for example at least partly in parallel. The task-specific variable data 206 for the task can be moved to the physical storage location of the core for executing that task, based on the data move instruction, and then used to execute an operation of that task using the execution unit, e.g. as described with reference to FIGS. 1 and 2. In a similar manner, the further handling unit of the further core in this example is configured to obtain further task data that describes the further task. The further task data comprises further task-specific variable data representative of a further task-specific variable for use in executing a further operation of the further task. The further handling unit is configured to move the further task-specific variable data into a further physical storage location of the further storage of the further core, based on the data move instruction, and to dispatch further invocation data, based on the further task data and the further physical storage location, to the further execution unit to cause the further execution unit to execute the further operation.

The task executed by the core for example comprises applying the operation to a first portion of a tensor and the further task executed by the further core for example comprises applying the operation to a second portion of the tensor. The portion of the tensor to be processed by each respective core could be indicated by the (compiled) task data for the respective task, with a different task upper and lower bound for each core. However, to provide greater flexibility, examples herein instead define each respective task based on the task-specific variable data for that task, which can be provided to the handling unit for the respective core even after the task data for the task to be executed by that core has been compiled. In an example, the task data comprises reference data defining a reference portion of the tensor and the handling unit of the core is configured to process the reference data based on the task-specific variable data to obtain first tensor data defining the first portion of the tensor. In this case, the further task data also comprises the reference data, and the further handling unit is configured to process the reference data defining a reference portion of the tensor and the handling unit is configured to process the reference data based on the task-specific variable data to obtain first tensor data defining the first portion of the tensor. In this way, different respective portions of a tensor to be processed by different respective cores in executing respective tasks of a job can be defined relative to the reference portion of the tensor, using the task-specific variable data for the respective core. As the first and second portions of the tensor may be different, the task-specific variable data and the further task-specific variable data for example represent different respective offsets or translations to be applied to the reference portion of the tensor. It is to be appreciated, though, that the manner in which a tensor is divided into different respective portions for execution on different respective cores may be more complex than a simple translation. For example, the division of a tensor into portions, each corresponding to a respective portion of a job, may be performed by a host processor, such as a central processing unit, which is configured to instruct the execution of the job by the apparatus comprising a plurality of processor cores (which may be a hardware accelerator, for example). This is discussed further below with reference to FIG. 3.

Use of the task-specific variable data and the further task-specific variable data to define first and second portions of a tensor to be operated on by the core and the further core, respectively, may allow the first and second portions of the tensor to be defined relative to a reference portion of the tensor that is itself defined in such a way as to reduce an amount of data to be stored or transferred by the core and/or further core in executing the job. For example, the reference portion of the tensor may be defined with low and high bounds set to zero in a plurality of dimensions (e.g. as many dimensions as possible), to reduce or minimise the size of tensor data representing the reference portion of the tensor from which the low and high bounds of the first and second portions of the tensor can be calculated, using the task-specific variable data and the further task-specific variable data.

### Input Reader Operation

In an example, the task-specific variable represented by the task-specific variable data 206 corresponds to a predetermined value to be used in response to an attempt to access an out-of-bounds value during execution of an operation by an execution unit. In this example, the operation is a so-called “input reader” operation, comprising reading data from storage, for example data representing a portion of a tensor to be processed (such as a block of a tensor to which an operation, e.g. the convolution operation described above, is to be applied). In this operation, the data is read by an execution unit (for example an input reader, as described further below with reference to FIG. 5) from storage external to an apparatus comprising the handling unit and the execution unit.

The input reader operation may involve attempting to access, e.g. read, data that is outside the range of the tensor in at least one dimension, or data at an address indicated by a pointer with an illegal pointer value such as −1. For example, the input reader may receive invocation data from the handling unit that instructs the input reader to read, from the external storage, a portion of a tensor with at least one out-of-bounds coordinate, which is beyond or otherwise outside a coordinate range of the tensor that is stored in the external storage in at least one dimension. If this is the case, the input reader may attempt to read data from the external storage representing this portion of the tensor, which is outside the bounds of what the input reader is permitted to access. Rather than returning an error, the input reader instead returns the task-specific variable data 206 in response to the attempt to access the out-of-bounds value. For example, the task-specific variable data 206 can be provided to the execution unit (in this case, the input reader) via the invocation data, after performing a data move instruction as described above, and returned by the input reader if the input reader operation instructed by the invocation data involves attempting to access an out-of-bounds value, such as an out-of-bounds coordinate and/or a coordinate with a negative value. For example, the task-specific variable data 206 may be moved to at least a portion of an unused boundary register (such as a low or high portion 210a, 210b) by the handling unit, based on the data move instruction, before generation of the invocation data by the handling unit. This allows the execution unit, e.g. the input reader, to return the task-specific variable data 206 in the event that the execution unit is unable to read an in-bounds value from the external storage.

The task-specific variable data 206 may be considered to represent a predetermined value, such as a default value, which can be obtained by an input reader instead of the value indicated by the invocation data, if the value indicated by invocation data is represented by data that is out-of-bounds. Using the task-specific variable as the predetermined value for example provides greater flexibility than using a predefined constant value. For example, the value of the task-specific variable can be set after compilation and may differ for different blocks of data that are read. The predetermined value represented by the task-specific variable data 206 may be number, such as zero or a non-zero integer, or a predefined bit pattern, for example to represent a positive or negative infinity value or a NaN (not-a-number) value.

### Execution of a Directed Graph

Many data structures to be executed in a processor can be expressed as a directed graph. Examples of such data structures include neural networks which can be represented as a directed graph of operations that wholly compose the operations required to execute a network (i.e. to execute the operations performed across the layers of a neural network). A directed graph of operations may comprise an operation using task-specific variable data as described in examples herein. Examples involving a directed graph of operations will now be described.

A directed graph is a data structure of operations (which may be referred to herein as ‘sections’) having directed connections therebetween that indicate a flow of operations. The connections between operations (or sections) present in the graph of operations may be referred to as pipes (where a given connection is the sole tenant of a particular region of the storage unit, which region may be allocated to that connection statically or dynamically) or sub-pipes (where a given connection shares a particular region of the storage unit with at least one other connection). The allocation of particular storage elements within a given region of the storage unit to different respective sub-pipes that are tenants of the given region of the storage unit may be performed dynamically. A plurality of sub-pipes may belong to the same pipe as each other, which may be referred to as a multi-pipe. In such cases, the multi-pipe may be the sole tenant of the given region of the storage unit, which may itself be statically or dynamically allocated to the multi-pipe. A directed graph may contain any number of divergent and convergent branches. A directed graph may contain any number of divergent and convergent branches.

FIG. 3 illustrates an example directed graph 11 in which sections are interconnected by pipes or sub-pipes. Specifically, an initial section, section 1 (1110) represents a point in the directed graph at which an operation, operation A, is to be performed when executing the graph. The output of operation A at section 1, 1110, is connected to two further sections, section 2 (1120) and section 3 (1130) at which respective operations B and C are to be performed. The connection between section 1 (1110) and section 2 (1120) can be identified as a pipe with a unique identifier, pipe 1 (1210). The connection between section 1 (1110) and section 3 (1130) can be identified as a pipe with a different unique identifier, pipe 2 (1220). The output of section 1, which is the result of performing operation A on the input to section 1, can be provided to multiple subsequent sections in a branching manner.

More generally, sections in the directed graph may receive multiple inputs, each from a respective different section in the directed graph via a respective different pipe or sub-pipe. In FIG. 3, sections 2 and 3 (1120, 1130) each write to different respective sub-pipes (1230, 1240, 1250, 1260) of the same pipe, pipe 3, which is a multi-pipe. Each sub-pipe has its own unique identifier, which also indicates the multi-pipe to which the sub-pipe belongs, where a multi-pipe is a pipe comprising at least one sub-pipe, as explained above. In this case, section 2 writes to sub-pipes 3.0 and 3.1 (1230, 1240) and section 3 writes to sub-pipes 3.2 and 3.3 (1250, 1260), where the numeral prior to the period indicates the identifier of the multi-pipe (3) and the numeral after the period indicates the identifier of the sub-pipe of the multi-pipe (0 to 3 in this case). A region of a storage unit is allocated to multi-pipe 3, and respective storage elements of the region of the storge unit are dynamically allocated to sub-pipes 3.0 to 3.3. In this example, different sections (sections 2 and 3) thus write to the same underlying physical region of the storage unit, via dynamically allocated sub-pipes.

The directed graph 11 of FIG. 3 also includes sections 4 to 6 (1140 to 1170) and pipes 4 to 6 (1270 to 1290). The sections 4 and 6 (1140, 1160) receive input data from sub-pipes 3.0 and 3.3 (1230, 1260) respectively, and write data to pipes 4 and 6 (1270, 1290) respectively. Section 5 (1150) in FIG. 3 receives a first set of input data via sub-pipe 3.1 (1240) from section 2 (1120) and a second set of input data via sub-pipe 3.2 (1250) from section 3 (1130) and writes data to pipe 5 (1280). Section 7 (1170) of the directed graph 11 receives input data from pipes 4 to 6 (1270 to 1290). Depending on the nature of the operation performed in a particular section and the dependencies of subsequent operations on the output of the operation, any number of input and output pipes may be connected to a particular section in the directed graph.

The directed graph can be represented by a number of sub-graphs each containing a subset of the sections in the graph. FIG. 3 illustrates an arrangement where the graph 11 is broken down into three sub-graphs 1310, 1320, and 1330 which can be connected together to form the complete graph. For example, sub-graph 1310 contains sections 1 and 3 (1110 and 1130) as well as pipe 2 and sub-pipe 3.3 (1220 and 1260)), sub-graph 1320 contains section 2, 4 and 5 (1120, 1140, and 1150) as well as pipe 1 and sub-pipes 3.0 to 3.2 (1210, 1230, 1240, and 1250), and sub-graph 1330 contains sections 6 and 7 (1160 and 1170) as well as pipes 4 to 6 (1270, 1280, and 1290).

### Operation Space

When executing progressions of operations, for example structured in a directed graph, each section could represent a different operation. It is not necessary for each operation to be of the same type or nature. This is particularly the case where the graph of operations is used to represent the processing of a neural network. The machine learning software ecosystem allows for a diverse structure of neural networks that are applicable to many different problem spaces, and as such there is a very large possible set of operators from which a neural network can be composed.

It is desirable to define a set of pre-determined low-level operations from which a broad range of possible higher-level operations that correspond with various machine learning tool sets can be built. One example of such a low-level set of operations, is the Tensor Operator Set Architecture (TOSA). The Tensor Operator Set Architecture (TOSA) provides a set of whole-tensor operations commonly employed by Deep Neural Networks. The intent is to enable a variety of implementations running on a diverse range of processors, with the results at the TOSA level consistent across those implementations. Applications or frameworks which target TOSA can therefore be deployed on a wide range of different processors, including single-instruction multiple-data (SIMD) CPUs, graphics processing units (GPUs) and custom hardware such as neural processing units/tensor processing units (NPUs/TPUs), with defined accuracy and compatibility constraints. Most operators from the common ML frameworks (TensorFlow, PyTorch, etc.) should be expressible in TOSA. Many of the operations in a defined operation set (such as TOSA) can be represented as a loop of scalar operations, such as the 2D convolution operation discussed above.

### Hardware Implementation

As described above, a data structure in the form of a directed graph may comprise plural sequenced operations that are connected to one another for execution in a progression. Described below is an example hardware arrangement for executing linked operations for at least a portion of a directed graph as illustrated in FIG. 3.

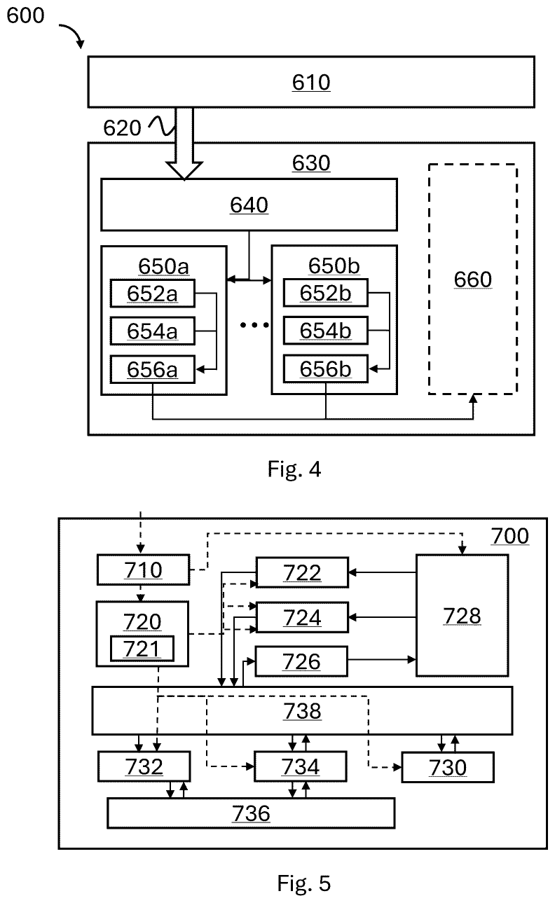

FIG. 4 shows schematically an example of a data processing system 600 including a processor 630 which may act as a co-processor or hardware accelerator unit for a host processing unit 610. It will be appreciated that the types of hardware accelerator which the processor 630 may provide dedicated circuitry for is not limited to that of Neural Processing Units (NPUs) or Graphics Processing Units (GPUs) but may be dedicated circuitry for any type of hardware accelerator. GPUs may be well-suited for performing certain types of arithmetic operations such as neural processing operations, as these operations are generally similar to the arithmetic operations that may be required when performing graphics processing work (but on different data formats or structures). Furthermore, GPUs typically support high levels of concurrent processing (e.g. supporting large numbers of execution threads), and are optimized for data-plane (rather than control plane) processing, all of which means that GPUs may be well-suited for performing other types of operations.

That is, rather than using entirely separate hardware accelerators, such as a machine learning processing unit that is independent of the graphics processor, such as an NPU, or only being able to perform machine learning processing operations entirely using the hardware of the GPU, dedicated circuitry may be incorporated into the GPU itself.

This means that the hardware accelerator circuitry incorporated into the GPU is operable to utilize some of the GPU's existing resources (e.g. such that at least some functional units and resources of the GPU can effectively be shared between the different hardware accelerator circuitry, for instance), whilst still allowing an improved (more optimized) performance compared to performing all the processing with general purpose execution.

As such, the processor 630 may be a GPU that is adapted to comprise a number of dedicated hardware resources, such as those which will be described below.

In some examples, this can be particularly beneficial when performing machine learning tasks that themselves relate to graphics processing work, as in that case all of the associated processing can be (and preferably is) performed locally to the graphics processor, thus improving data locality, and (e.g.) reducing the need for external communication along the interconnect with other hardware units (e.g. an NPU). In that case, at least some of the machine learning processing work can be offloaded to the machine learning processing circuit, thereby freeing the execution unit to perform actual graphics processing operations, as desired.

In other words, in some examples, providing a machine learning processing circuit within the graphics processor means that the machine learning processing circuit may then be operable to perform at least some machine learning processing operations whilst the other functional units of the graphics processor are simultaneously performing graphics processing operations. In the situation where the machine learning processing relates to part of an overall graphics processing task this can therefore improve overall efficiency (in terms of energy efficiency, throughput, etc.) for the overall graphics processing task.

In FIG. 4, the processor 630 is arranged to receive task data 620 from a host processor 610, such as a central processing unit (CPU). The task data comprises at least one command in a given sequence, each command to be executed, and each command may be decomposed into a number of tasks, such as tasks discussed in this disclosure. These tasks may be self-contained operations, such as a given machine learning operation or a graphics processing operation. It will be appreciated that there may be other types of tasks depending on the command. For example, the task data 620 may comprise an instruction to configure the processor 630 to perform the task. The instruction may be sent from the host processor 610 (e.g. from accelerator control interface circuitry, discussed further below with reference to FIG. 7) to control interface circuitry of the processor 630 as a set of command messages.

The task data 620 is sent by the host processor 610 and is received by a command processing unit 640 which is arranged to schedule the commands within the task data 620 in accordance with their sequence. The task data 620 may be received by the control interface circuitry of the processor 630 and then sent to the command processing unit 640, or the command processing unit 240 may comprise the control interface circuitry for receiving messages from the host processor 610. The command processing unit 640 is arranged to schedule the commands and decompose each command in the task data 620 into at least one task. For example, the command processing unit 640 may comprise accelerator processing circuitry configured to reconstruct the instruction from the set of command messages, e.g. as described further below with reference to FIG. 7. Once the command processing unit 640 has scheduled the commands in the task data 620, and generated a plurality of tasks for the commands, the command processing unit 640 issues each of the plurality of tasks to at least one compute unit 650a, 650b each of which are configured to process at least one of the plurality of tasks.

The processor 630 comprises a plurality of compute units 650a, 650b. Each compute unit 650a, 650b, may be a shader core of a GPU specifically configured to undertake a number of different types of operations, however it will be appreciated that other types of specifically configured processor may be used, such as a general-purpose processor configured with individual compute units, such as compute units 650a, 650b. Each compute unit 650a, 650b may each comprise a different respective processor core (which may be referred to herein as a “core”) to enable parallel processing. Each compute unit 650a, 650b comprises a number of components, and at least a first processing module 652a, 652b for executing tasks of a first task type, and a second processing module 654a, 654b for executing tasks of a second task type, different from the first task type. In some examples, the first processing module 652a, 652b may be a processing module for processing neural processing operations, such as those which would normally be undertaken by a separate NPU. In these cases, the first processing module 652a, 652b is for example a neural engine. Similarly, the second processing module 654a, 654b may be a processing module for processing graphics processing operations forming a set of pre-defined graphics processing operations which enables the implementation of a graphics processing pipeline, which may be referred to as a graphics processor. For example, such graphics processing operations include a graphics compute shader task, a vertex shader task, a fragment shader tasks, a tessellation shader task, and a geometry shader task. These graphics processing operations may all form part of a set of pre-defined operations as defined by an application programming interface, API. Examples of such APIs include Vulkan, Direct3D and Metal. Such tasks would normally be undertaken by a separate/external GPU. It will be appreciated that any number of other graphics processing operations may be capable of being processed by the second processing module.

As such, the command processing unit 640 issues tasks of a first task type to the first processing module 652a, 652b of a given compute unit 650a, 650b, and tasks of a second task type to the second processing module 654a, 354b of a given compute unit 650a, 650b. The command processing unit 640 would issue machine learning/neural processing tasks to the first processing module 652a, 652b of a given compute unit 650a, 650b where the first processing module 652a, 652b is optimized to process neural network processing tasks, for example by comprising an efficient means of handling a large number of multiply-accumulate operations. Similarly, the command processing unit 640 would issue graphics processing tasks to the second processing module 654a, 654b of a given compute unit 650a, 650b where the second processing module 652a, 654a is optimized to process such graphics processing tasks. In some examples, the first and second tasks may both be neural processing tasks issued to a first processing module 652a, 652b, which is a neural engine. Such a neural processing task may involve the processing of a tensor, e.g. representing a feature map, with weights associated with a layer of a neural network.

In addition to comprising a first processing module 652a, 652b and a second processing module 654a, 654b, each compute unit 650a, 650b also comprises a memory in the form of a local cache 656a, 656b for use by the respective processing module 652a, 652b, 654a, 654b during the processing of tasks. Examples of such a local cache 656a, 656b is a L1 cache. The local cache 656a, 656b may, for example, a synchronous dynamic random-access memory (SDRAM). For example, the local cache 656a, 656b may comprise a double data rate synchronous dynamic random-access memory (DDR-SDRAM). It will be appreciated that the local cache 656a, 656b may comprise other types of memory.

The local cache 656a, 656b is used for storing data relating to the tasks which are being processed on a given compute unit 650a, 650b by the first processing module 652a, 652b and second processing module 654a, 654b. It may also be accessed by other processing modules (not shown) forming part of the compute unit 650a, 650b the local cache 656a, 656b is associated with. However, in some examples, it may be necessary to provide access to data associated with a given task executing on a processing module of a given compute unit 650a, 650b to a task being executed on a processing module of another compute unit (not shown) of the processor 630. In such examples, the processor 630 may also comprise storage 660, for example a cache, such as an L2 cache, for providing access to data for the processing of tasks being executed on different compute units 650a, 650b.

By providing a local cache 656a, 656b tasks which have been issued to the same compute unit 650a, 650b may access data stored in the local cache 656a, 656b, regardless of whether they form part of the same command in the task data 620. The command processing unit 640 is responsible for allocating tasks of commands to given compute units 650a, 650b such that they can most efficiently use the available resources, such as the local cache 656a, 656b, thus reducing the number of read/write transactions required to memory external to the compute units 650a, 650b, such as the storage 660 (L2 cache) or higher-level memories. One such example, is that a task of one command issued to a first processing module 652a of a given compute unit 650a, may store its output in the local cache 656a such that it is accessible by a second task of a different (or the same) command issued to a given processing module 652a, 654a of the same compute unit 650a.

One or more of the command processing unit 640, the compute units 650a, 650b, and the storage 660 may be interconnected using a bus. This allows data to be transferred between the various components. The bus may be or include any suitable interface or bus. For example, an ARM® Advanced Microcontroller Bus Architecture (AMBAR) interface, such as the Advanced extensible Interface (AXI), may be used.

FIG. 5 is a schematic diagram of a neural engine 700, which in this example is used as a first processing module 652a, 652b in a data processing system 600 in accordance with FIG. 4. The neural engine 700 includes a command and control module 710. The command and control module 710 receives tasks from the command processing unit 640 (shown in FIG. 4), and also acts as an interface to storage external to the neural engine 700 (such as a local cache 656a, 656b and/or a L2 cache 660) which is arranged to store data to be processed by the neural engine 700 such as data representing a tensor, or data representing a stripe of a tensor. In the context of the present disclosure, a stripe is a subset of a tensor in which each dimension of the stripe covers a subset of the full range of the corresponding dimension in the tensor. The external storage may additionally store other data to configure the neural engine 700 to perform particular processing and/or data to be used by the neural engine 700 to implement the processing such as neural network weights.

The command and control module 710 interfaces to a handling unit 720, which is for example a traversal synchronization unit (TSU). In this example, each task corresponds to a stripe of a tensor which is to be operated upon in accordance with a sequence of operations according to at least a portion (e.g. a sub-graph) of the directed graph representation of the neural network. The tensor for example represents a feature map for processing using the neural network. A neural network typically includes a sequence of layers of processing, with an output from each layer being used as an input to the next layer. Each layer for example processes an input feature map by operating upon the input feature map to generate an output feature map, which is used as the input feature map for the next layer. The term “feature map” is used generically herein to refer to either an input feature map or an output feature map. The processing performed by a given layer may be taken to correspond to an operation.

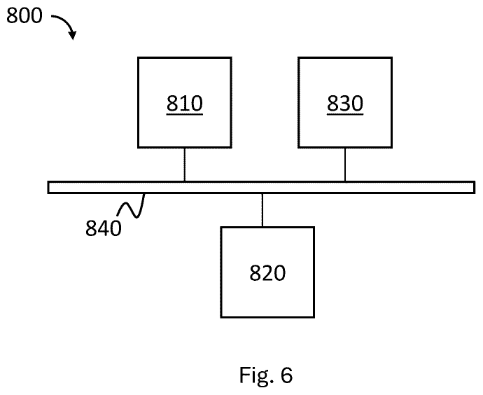

In this example, the handling unit 720 splits data representing a stripe of a feature map into a plurality of blocks of data, each of which represents a respective part of the feature map. The handling unit 720 also obtains, from storage external to the neural engine 700 such as the L2 cache 660, task data defining operations selected from an operation set comprising a plurality of operations. In this example, the operations are structured as a progression of operations representing a sequence of layers of the neural network. The operations are representable as a directed graph of operations, e.g. as described with reference to FIG. 6a, comprising operations connected by connections corresponding to respective logical storage locations, such that a connection associated with an output of an operation of the operations corresponds to a logical storage locations. A block of data is allocated as an input to one of the operations by the handling unit 720.

The handling unit 720 coordinates the interaction of internal components of the neural engine 700, which include a weight fetch unit 722, an input reader 724, an output writer 726, a direct memory access (DMA) unit 728, a dot product unit (DPU) array 730, a vector engine 732, a transform unit 734, an accumulator buffer 736, and a shared storage 738, for processing of blocks of data. The data dependencies across the functional units are tracked by the handling unit 720. Processing is initiated by the handling unit 720 in a functional unit if all input blocks are available and space is available in the shared storage 738 of the neural engine 700. The shared storage 738 may be considered to be a shared buffer, in that various functional units of the neural engine 700 share access to the shared storage 738.

The task-specific variable data may be moved to a physical storage location in storage 721 of the holding unit 720. For example, the storage 721 may be or comprise a plurality of working registers (such as the boundary registers 210 of FIG. 2). For example, there may be a boundary register per functional unit, so that the task-specific variable data for execution of a task by a particular functional unit (which is an example of an execution unit) can be stored in the boundary register for that functional unit. In other cases, though, a boundary register may be used to store data for use by a plurality of functional units. In coordinating the execution of a particular operation, the handling unit 720 moves the task-specific variable data to the storage 721. The task-specific variable data may undergo modification while in the storage 721, for example to update a value of the task-specific variable represented by the task-specific variable data. The handling unit 720 then sends invocation data comprising the task-specific variable data from the storage 721 to a functional unit to instruct the functional unit to execute the particular operation. The invocation data can be sent from the handling unit 720 to the functional unit using at least one command or message.

In the context of a directed graph representing the operations to be performed, each of the internal components that operates upon data can be considered to be one of two types of component. The first type of component is an execution unit (and is identified within the neural engine 700 as such) that maps to a section that performs a specific instance of an operation within the directed graph. The execution unit may be implemented using execution circuitry and may thus be referred to interchangeably as execution circuitry. For example, the weight fetch unit 722, input reader 724, output writer 726, dot product unit array 730, vector engine 732, transform unit 734 each are configured to perform one or more pre-determined and fixed operations upon data that it receives. Each of these sections can be uniquely identified with an identifier and each execution unit can also be uniquely identified.

Similarly, all physical storage elements within the neural engine (and in some instances portions of those physical storage elements) can be considered to be uniquely identified within the neural engine. The handling unit 720 is configured to allocate storage elements to respective connections in the directed graph, which can correspond to pipes as explained above. For example, portions of the accumulator buffer 736 and/or portions of the shared storage 738 can each be regarded as a storage element that can act to store data for a pipe or a sub-pipe within the directed graph, as allocated by the handling unit 720. A pipe or a sub-pipe can act as a connection between sections (as executed by execution units) to enable a sequence of operations as defined in the directed graph to be linked together within the neural engine 700. Put another way, the logical dataflow of the directed graph can be mapped to the physical arrangement of execution units and storage elements within the neural engine 700. Under the control of the handling unit 720, execution can be scheduled on the execution units and data can be passed between the execution units via the storage elements in accordance with the mapping, such that the linked operations of a graph can be executed without needing to write data memory external to the neural engine 700 between executions. The handling unit 720 is configured to control and dispatch work representing performing an operation of the graph on at least a portion of the data provided by a pipe or a sub-pipe.

The weight fetch unit 722 fetches weights associated with the neural network from external storage and stores the weights in the shared storage 738. The input reader 724 reads data to be processed by the neural engine 700 from external storage, such as a block of data representing part of a tensor. The output writer 726 writes data obtained after processing by the neural engine 700 to external storage. The weight fetch unit 722, input reader 724 and output writer 726 interface with the external storage (which is for example the local cache 656a, 656b, which may be a L1 cache such as a load/store cache) via the DMA unit 728.

Data is processed by the DPU array 730, vector engine 732 and transform unit 734 to generate output data corresponding to an operation in the directed graph. The result of each operation is stored in a specific pipe or sub-pipe within the neural engine 700. The DPU array 730 is arranged to perform one or more operations associated with a dot product operation between two operands, such as between an array of weights and a corresponding block of data (e.g. representing part of a tensor). The vector engine 732 is arranged to perform elementwise operations, for example to apply scale parameters to scale an output of a dot product calculated by the DPU array 730.

Data generated during the course of the processing performed by the DPU array 730 and the vector engine 732 may be transmitted for temporary storage in the accumulator buffer 736 from where it may be retrieved by either the DPU array 730 or the vector engine 732 (or another different execution unit) for further processing as desired.

The transform unit 734 is arranged to perform in-block transforms such as dimension broadcasts or axis swaps. The transform unit 734 obtains data (e.g. after processing by the DPU array 730 and/or vector engine 732) from a pipe or a sub-pipe, for example mapped to at least a portion of the shared storage 738 by the handling unit 720. The transform unit 734 writes transformed data back to the shared storage 738.

To make efficient use of the shared storage 738 available within the neural engine 700, the handling unit 720 determines an available portion of the shared storage 738, which is available during execution of part of a first task (e.g. during processing of a block of data associated with the first task by the DPU array 730, vector engine 732 and/or transform unit 734). The handling unit 720 determines a mapping between at least one logical address associated with data generated during execution of a second task (e.g. by processing of a block of data associated with the second task by the DPU array 730, vector engine 732 and/or transform unit 734) and at least one physical address of the shared storage 738 corresponding to the available portion. The logical address is for example a global address in a global coordinate system. Hence, by altering the physical address corresponding to a given logical address, the handling unit 720 can effectively control usage of the shared storage 738 without requiring a change in software defining the operation to be performed, as the same logical address can still be used to refer to a given element of the tensor to be processed. The handling unit 720 identifies the at least one physical address corresponding to the at least one logical address, based on the mapping, so that data associated with the logical address is stored in the available portion. The handling unit 720 can perform the mapping process according to any of the examples herein.

In an analogous manner, the handling unit 720 can determine a mapping between logical storage locations (e.g. corresponding to respective logical addresses) corresponding to respective connections within the directed graph and sets of storage elements (e.g. corresponding to sets of physical addresses within storage of the neural engine 700, such as within the accumulator buffer 736 and/or the shared storage 738). In this way, the handling unit 720 can for example dynamically allocate first and second sets of storage elements to correspond to first and second logical storage locations associated with first and second operations (e.g. first and second sections) of the directed graph.

The handling unit 720 can for example allocate respective physical storage locations (e.g. corresponding to respective storage elements of the storage of the neural engine 700, such as respective buffers of the accumulator buffer 736 and/or the shared storage 738) for storing respective blocks generated by an operation of the directed graph, such as by a production operation. In allocating the physical storage locations, the handling unit 720 may map logical storage locations (e.g. corresponding to respective logical addresses) corresponding to respective connections within the directed graph to respective sets of storage elements. The mapping may be performed dynamically by the handling unit 720, to utilize the storage of the neural engine 700 more efficiently.

It will be appreciated that in a graph of operations there does not need to be only a single instance of a particular type of operation. For example, multiple instances of a convolution operation could be present in a graph of operations. In the above example hardware arrangement only a single convolution engine may be present. Therefore, it will be appreciated that there does not need to be a direct 1:1 mapping between operations in the graph (sections) and execution units, and similarly no direct 1:1 mapping between pipes and storage elements and/or between sub-pipes and storage elements. In particular, a single execution unit may be configured at different instances in time to execute different instances of a convolution operation (e.g. first and second sections). Similarly, the input reader may be required to read data as part of different sections in the graph. The same can be said for storage elements and pipes and/or sub-pipes.

All storage in the neural engine 700 may be mapped to corresponding pipes and/or sub-pipes, including look-up tables, accumulators, etc., as discussed further below. The width and height of pipes and/or sub-pipes can be programmable, resulting a highly configurable mapping between pipes, sub-pipes and storage elements within the neural engine 700. For example, the handling unit 720 may map a source logical storage location to a source physical storage location of the storage and a destination logical storage location to a destination physical storage location of the storage, with at least one of the source physical storage location and the destination physical storage location corresponding to a connection between an operation to be executed in executing the task described by the task data and a further operation in the directed graph to which the operation is connected. In these examples, the invocation data dispatched by the handling unit 720 to an execution unit may describe at least one of the source or destination physical storage locations, so as to instruct the execution unit to read and/or write data at one of these locations in executing the operation.

Ordering of execution of the sections is implied by dependencies on inputs. A memory load operation has no data dependencies (unless it is a gather operation), so is implicitly early in the graph. The consumer of the pipe (or sub-pipe) that the memory read produces is implicitly after the memory read. A memory store operation is near the end of the graph, as it produces no pipes or sub-pipes for other operations to consume. The sequence of execution of a progression of operations is therefore handled by the handling unit 720.

### System for Allocating Handling Data

FIG. 6 shows schematically a system 800 for allocating handling data, and in some examples generating a plurality of blocks of input data for processing.

The system 800 comprises host processor 810 such as a central processing unit, or any other type of general processing unit. The host processor 810 issues task data comprising a plurality of commands, each having a plurality of tasks associated therewith.

The system 800 also comprises a processor 830, which may be similar to or the same as the processor 630 of FIG. 4 and may comprise at least some of the components of and/or be configured to perform the methods described above. The processor 830 comprises at least a plurality of compute units 650a, 650b and a command processing unit 640. Each compute unit may comprise a plurality of processing modules each configured to perform at least one type of operation. The system 800 may also include at least one further processor (not shown), which may be the same as the processor 830. The processor 830, and the host processor 810 may be combined as a System on Chip (SoC) or onto multiple SoCs to form one or more application processors.

The system 800 also comprises memory 820 for storing data generated by the tasks externally from the processor 830, such that other tasks operating on other processors may readily access the data. However, it will be appreciated that the external memory usage will be used sparingly, due to the allocation of tasks as described above, such that tasks requiring the use of data generated by other tasks, or requiring the same data as other tasks, will be allocated to the same compute unit 650a, 650b of a processor 830 so as to maximize the usage of the local cache 656a, 656b.

In some examples, the system 800 may comprise a memory controller (not shown), which may be a dynamic memory controller (DMC). The memory controller is coupled to the memory 820. The memory controller is configured to manage the flow of data going to and from the memory. The memory may comprise a main memory, otherwise referred to as a ‘primary memory’. The memory may be an external memory, in that the memory is external to the system 800. For example, the memory 820 may comprise ‘off-chip’ memory. The memory may have a greater storage capacity than local caches of the processor 830 and/or the host processor 810. In some examples, the memory 820 is comprised in the system 800. For example, the memory 820 may comprise ‘on-chip’ memory. The memory 820 may, for example, comprise a magnetic or optical disk and disk drive or a solid-state drive (SSD). In some examples, the memory 820 comprises a synchronous dynamic random-access memory (SDRAM). For example, the memory 820 may comprise a double data rate synchronous dynamic random-access memory (DDR-SDRAM).

One or more of the host processor 810, the processor 830, and the memory 820 may be interconnected using a system bus 840. This allows data to be transferred between the various components. The system bus 840 may be or include any suitable interface or bus. For example, an ARM® Advanced Microcontroller Bus Architecture (AMBAR) interface, such as the Advanced extensible Interface (AXI), may be used.

### Neural Engine Program Descriptor (NED)

As explained above, the neural engine 700 receives tasks from the command processing unit 640 to execute operations from the directed graph. The neural engine 700 is configured to execute operations selected from a base set of operations defining an operator set. One example of such an operator set is the Tensor Operator Set Architecture (TOSA) base inference profile, which defines a set of operations that can collectively be used to define the operations of a wide range of neural network operations. One exception to the TOSA operator set is control flow operations that may be implemented by way of task data processed by the command processing unit 640. It will be appreciated that there may be multiple neural engines with the processor 630 and thus multiple tasks can be issued concurrently to different neural engines.

In an example implementation, a task issued by the command processing unit 640 for execution by the neural engine 700 is described by task data which in this example is embodied by a neural engine program descriptor (NED), which is a data structure stored in memory and retrieved by the neural engine when executing the task issued by the command processing unit. The NED describes at least a portion of a complete graph of operations (sections) to be performed when executing the graph of operations (e.g. representing a neural network). As discussed above, sections are mapped to various hardware execution units within the neural engine 700 and essentially represent instantiations of a particular operator at a position within the graph. In one example, these sections are described by specific ‘elements’ that collectively define the operations forming part of the NED. Furthermore, the NED has an unordered list of pipes and/or sub-pipes (graph vertices) and an unordered list of sections/operations (graph nodes). Each operation specifies its input and output giving rise to adjacency of operation in the directed graph to which a particular operation is connected. An example NED comprises a NED structure comprising a header, the elements each corresponding to a section in the graph. The NED describes the various requirements of ordering, number and relationship of these sections and pipes and/or sub-pipes. In one implementation, each of the execution units and each storage element (or portion of a storage element) of the neural engine 700 has a sub-descriptor definition which defines how that execution unit/storage element can be configured for use in implementing a specific section, pipe or sub-pipe in the graph. An example of the hardware units and their corresponding elements is set out below:
Weight Fetch (WF): NEDWeightFetchElement
Input Reader (IR): NEDInputReaderElement
Output Writer (OW): NEDOutputWriterElement
Convolution Engine (CE): NEDConvolutionEngineElement
Transform Unit (TU): NEDTransformUnitElement
Vector Engine (VE): NEDVectorEngineElement

The NED therefore may specify the execution unit or in other words specify a compatible execution unit for each operation. In embodiments there may be more than one execution unit of a given type such as InputReader may have two command queues which can operate concurrently. A NED may specify which of the queues is assigned so that there remains a 1:1 relationship between what the NED specifies and the physical hardware to which it points.

The dataflow and dependencies of the task's graph is described by pipes and/or sub-pipes. Pipes and/or sub-pipes are used to represent data storage elements within the neural engine 700 and describe the relationship between sections (operations) in a producer-consumer relationship: the output destination pipe or sub-pipe (e.g. a pipe or sub-pipe number) and each input source pipe or sub-pipe (e.g. a pipe or sub-pipe number) for every section is defined in the NED elements of the NED. Pipes and sub-pipes each have only a single producer but may have multiple consumers. A pipe and/or a sub-pipe may be mapped to one of several different physical storage locations (e.g. storage units in the neural engine 700), but not all physical storage locations may be suitable for the different section operations. It will be appreciated that, in some arrangements, a pipe may be mapped to only a portion of a storage unit, which may include at least one storage element. For example, a physical buffer (or a set of physical buffers, which may be or form part of a memory bank) may be considered to be a storage unit, and a physical address (or a set of physical addresses) corresponding to or within a physical buffer may be considered to be a storage element. For example, a storage unit may correspond to a set of physical buffers and a storage element may be a physical buffer of the set of physical buffers, the physical buffer comprising a set of physical addresses. In such cases, a pipe and/or a sub-pipe can describe double-buffering (for example) behavior between its producer and consumers. The output data generated by a section and stored in a pipe or a sub-pipe is referred to equivalently as both a block (of data) and a (virtual) buffer, with a block of data occupying one physical buffer location. Irrespective of location, pipes and/or sub-pipes may be non-coherent with a wider memory system associated with the neural engine 700 and with processor 630, and data is stored out using the Output Writer element of the neural engine 700.

In some arrangements the NED may be configured such that the same pipe is used for multiple inputs, where any relevant usage constraints (such as format or location) are satisfied. For example, an element-wise multiply might have the same pipe for the two input operands in order to square the input. In examples, though, the NED may be configured such that each sub-pipe has a single producer.

In some embodiments, sections such as InputReader and WeightFetcher have no input pipes and/or sub-pipes and instead their data comes from external memory, such as an external cache or DRAM. By contrast, some sections, such as OutputWriter have no output pipes or sub-pipes. In this case, their data is written to external memory.

For a section to run, it must have all the appropriate buffers available for its input source pipes and/or sub-pipes. A section may produce a new buffer in its output destination pipe or sub-pipe and so there must be space available in the pipe or sub-pipe for this new buffer. The neural engine 700 is responsible for tracking all of these dependencies.

The NED is split into multiple data structures that may appear contiguously in memory to be read by the neural engine 700. In this example implementation, the NED header defines the dimensions of the operation space of the operations to be performed. Specifically, the NED header defines the total size of the NED (e.g. number of bytes to be used to represent the NED) as well as a count of the number of section and pipes that are present in the graph.

For each section and pipe in the graph, a count of a corresponding mapped sub-descriptor element types is represented in the NED header. For instance, where the graph (or sub-graph) contains a number of sections, each of those sections is to be executed on a particular compatible execution unit of the neural engine 700. For each section, an element of the appropriate type is therefore counted in the NED header in order to represent the hardware requirements needed to invoke execution of the graph. For example, for a section that defines a convolution operation, a corresponding configuration and invocation of a convolution engine execution unit would be required. Similar counts of instantiations of weight fetch and input read execution units are counted based on the presence of sections that use those operations. This is reflected in the count in the NED header against the weight fetch and input reader elements associated with the weight fetch and input reader units in the neural engine 700.

The NED also contains information that describes any divergent or convergent branches between sections and pipes. For example the NED identifies, for each pipe in the graph, the number of producers and consumers associated with that pipe.

The NED header therefore essentially identifies the operation space and a count of all instances of sections and pipes (for each type of hardware element that is to be allocated for instantiating a section or a pipe that will be required to execute the graph (or sub-graph)) defined by the NED. An illustrative example of at least a portion of the fields stored in the NED header is set out below. In addition to the NED header, the NED further comprises sub-descriptor elements (defining either the configuration of an execution unit or storage element to operate as a section or pipe) for each instance of a section and/or pipe. Each sub-descriptor element defines the configuration of the associated hardware element (either execution unit or storage element) required to execute the section and/or pipe.

An example of at least some of the fields in a NED header is set out below:

| Field | Min | Max |
|---|---|---|
| Operation space size for dimension 1 | — | — |
| Operation space size for dimension 2 | — | — |
| Operation space size for dimension 3 | — | — |
| Operation space size for dimension 4 | — | — |
| Operation space size for dimension 5 | — | — |
| Operation space size for dimension 6 | — | — |
| Operation space size for dimension 7 | — | — |
| Number of weight fetch and decode sections | 0 | 1 |
| Number of input reader sections | 1 | 7 |
| Number of output write sections | 1 | 7 |
| Number of convolution engine sections | 0 | 1 |
| Number of transform unit sections | 0 | 7 |
| Number of vector engine sections | 0 | 7 |
| Number of pipes | 1 | 15 |

The theoretical minimum and maximum operation space dimension sizes may be defined at compilation based on the configuration of the neural engine, specifically such that the operations of the task (e.g. sub-graph) can be performed without requiring intermediate data to be stored in a memory element outside of the neural engine. A practical approach to defining a task and its corresponding operation space is set out in more detail later.

The NED header may also comprise pointers to each of the sub-descriptor elements to enable the specific configuration of each element to be read by the handling unit 720.

As mentioned, each instance of the sub-descriptor element defines a configuration of the hardware element (e.g. execution unit or storage element) to which it relates. The following description will provide an example sub-descriptor for a convolution engine.

In an example, the convolution engine is an execution unit which is configured, when invoked, to perform a convolution or pooling operation selected from one or more convolution operations for which the convolution engine is configured. One such example is a 2D convolution operation as described above. In the example of the 2D convolution operation described above, the operation space is 7D-namely [oc, n, oy, ox, ic, ky, kx].

Field

Stride X and Stride Y
Dilation X and Dilation Y
Operation type (e.g. which type of
convolution operation is to be performed)
Input width and height
Pad Left
Pad Top
Source 0 pipe (input feature map pipe)
Source 1 pipe (weight pipe)
Destination pipe

In this example, the operation type may for example take the form of one of pooling (average or max pooling), 2D convolution, or 2D depth-wise convolution. The source 0 pipe field might identify from which pipe the convolution engine should read the input feature map data—this may for example be a specific portion of a shared buffer. Similarly the source 1 pipe field might indicate from which (different) portion of the shared buffer the weight data is to be retrieved. Finally, the destination pipe might indicate that an accumulation buffer is to act as the pipe for the output of the operation performed by the convolution engine. By identifying for a section specific source and/or destination pipes, which have unique identifiers in the task definition (the NED), any preceding or subsequent sections are implicitly connected and sequenced. Another sub-descriptor element referencing the destination pipe of a different section as a source pipe will inherently read that data and the buffer allocation for that destination pipe may only be released once all of the dependencies have been resolved (e.g. that the sections that rely on that portion of the accumulation buffer have all completed reading that data).

Similar sub-descriptor elements exist for all sections based on configuring the execution units to perform operations. For example, sub-descriptor elements may define destination and source pipes, a pointer to a transform from operation to section space, and a mode of operation for the section.

In this example implementation, pipes represent all storage within the neural engine: all allocation and memory management is handled through a task's NED Pipe definitions and the traversal through the sections that produce and consume these pipes. There is no sharing of pipes between tasks and therefore no architected sharing of data between tasks within the neural engine. A sub-descriptor element is defined in the NED for each pipe in the graph. An example of a pipe sub-descriptor is set out below:

| Field | Min | Max |
|---|---|---|
| Pipe location (e.g. accumulator buffer, | 0 | 2 |
| shared buffer, LUT memory) | | |
| Number of buffers occupied by the pipe | 1 | 16 |
| Starting bank in memory | 1 | 8 |
| Number of banks used by the pipe | 1 | 8 |
| Starting word | 0 | 255 |
| Number of words per buffer | 1 | 256 |

As will be described in more detail later, these descriptors are used to configure the hardware elements when invocation is triggered by the handling unit 720.

### Neural Engine Dimensions and Iteration

In examples, a neural engine task describes a 12D bounding box with dimensions numbered from 0 to 11. The task data provides a pointer to a NED, which defines the section operations of the directed graph representing the task. The bounding box for the dimension may be a sub-region of the full size of these dimensions. Different tasks and/or jobs may cover other sub-regions of these dimensions. The command processing unit 640 may issue different tasks to different neural engines. The NED additionally defines an increment size for each of the dimensions to be stepped through, known as a block size. Execution of the graph against this 12D operation-space can be considered as a series of nested loops.

This splits the execution of the task's operation-space into a series of blocks, with sections being invoked on a block-by-block basis, operating on a block's worth of data in every source and destination pipe. Consequently, defining a general operation space in a coordinate system having for example 12 dimensions may provide a low complexity pattern for execution of any task comprising operations on data, instead of relying on fixed functions per task type, which may encompass a significant risk of missing necessary combinations of patterns. By defining a common operation space in a coordinate space, it may be less complex to chain a plurality of operations to be executed on data to each other and coordinate execution of these functions. Operation space dimensions do not have a specific interpretation until they are projected into space for a specific task.

The mapping of operation blocks in the operation space to local blocks in an operation-specific local space enables local ranges of the local blocks in the local space to be obtained. These local ranges for example correspond to coordinate ranges within the operation-specific local space, to allow the local blocks to be identified and obtained for use in executing a particular operation.

The number of dimensions in use is dependent on the graph and its operations; not every section will run for increments in each dimension. For example, a convolution operation has a 7D operation-space but only a 4D output space through which the convolution operation increments and accumulates output; a VE scaling operation following a convolution thus only runs for increments in the first four dimensions.

The execution of a neural engine task may be defined by two separate iterative processes implemented in the handling unit. In one process, the handling unit iteratively steps through the task's operation-space in block units as defined by the block size of the NED. In the other process, the handling unit iteratively steps through the dataflow graph defined by the NED and, where permitted by the dimension rules described above, transforms each block into the relevant section space before invoking the section's execution unit with the transformed block by issuing invocation data.

In general, for most cases, these two processes are defined in the examples described herein to be architecturally independent. This means that the execution of any given block is defined definitively and completely in itself, in isolation of any other block or the state of the handling unit operation space iteration. The execution of blocks that are not in accordance with this operation space iteration and transformation will run to completion, but the results will not provide meaningful results with respect to full operation definitions of the Tensor Operator Set Architecture (TOSA).

In all cases, execution of a block must not extend beyond the block's section-space boundaries. Loading and storing of data (whether mapping the section-space to coordinates of a tensor in memory, to pipes, or any other memory or pipe storage) may extend beyond the section-space as required by an implementation's granularity of access, but must not extend beyond the size of a pipe's buffer. When the section space is smaller than the pipe buffer, certain reduction operations may have an additional requirement to not modify the data in the buffer beyond the section space but other operations or execution units need not have this requirement.

Iterating over the operation space may generate a block with one or more execution dimensions that are zero and/or a block with a low bound that is higher than a high bound, meaning that no functional operation is required. This may occur due to padding before the start of operation space or clipping at the end of operation space, for example. Such a block may nevertheless still be dispatched to the execution unit for correct tracking of dependencies and execution ordering.

### Programmability of Operation Space to Section Space Transforms

As discussed above, the operation space for a task (sub-graph) may contain a pre-determined number of dimensions (e.g. eight), but the local section space for the operation to be performed for a specific section in that graph can contain fewer than 8 dimensions. The handling unit may iterate through the operation space in units known as blocks, transforming each block from the common operation space to a section-specific space (which may be referred to herein as a section space or an operation-specific local space) described by the various fields in the NED. For example, the handling unit may read a block size from the NED and iterate through the operation space one block at a time. For each block, a transform program is executed to transform the operation space coordinates to section space coordinates for that section. Once the section space coordinates have been determined, the section operation is performed in respect of that block. This process is iterated over all blocks until the operation is completed for all blocks.

In an example implementation, the NED may further comprise for each element in the NED (e.g. each section/pipe) a program comprising transform program data that describes a transform from operation space to section space (local space) for the corresponding section. This program may be referred to as a transform program. In one such implementation, each element in the NED may comprise an offset value that points to the specific program within the NED for executing the transform. This offset value may be regarded as a pointer into ‘program space’, being the space in which all the programs which define the various enabled transforms are located. Alternatively, the offset value may be a pointer into a virtual address space in main memory. For example, this program space can be defined in the NED as a field tsu_space_size which for example is sized as 256 bytes. The offset may point to a memory location at which the start of its section-space transform is placed (e.g. the first instruction in a sequence of instructions which collectively define a program for performing the transform).

Each transform program may end with an explicit END instruction, and may be followed without any spacing or alignment by a next program defining a sequence of instructions for executing a different transform that is associated with a different element. Alternatively a starting pointer may be used in conjunction with a total number of instructions to execute.

In an example implementation, the sequence of instructions used for each transform may be selected from a set of pre-determined instructions which effectively form an instruction set. This instruction may be regarded as a transform instruction set which may be a specific set of instructions selected optimally to perform transforms from operation space to section space. Alternatively, the transforms may be general purpose instruction set as seen in a central processing unit (CPU).

In an example implementation, a transform instruction may operate on a set of state values for the transform. The state values comprise boundary registers (in one example eight boundary registers b[0] to b[7]) each comprising a low and a high component, which may be referred to as a low and a high bound, respectively, as explained with reference to FIG. 2. Each block in the operation space is defined by the values described in the low and high components of the eight boundary registers. These values indicate the upper and lower bounds (inclusive) for the coordinates in the block for that axis of the “bounding box” operation space. As explained above, though, these boundary registers may also be used to store task-specific variable data to be used in executing the operation. In an example, the data move instruction 207 described above with reference to FIG. 2 is an instruction within the transform program for a given element in the NED, which for example comprises transform program data describing a transformation from operation space to section space for that element in the NED.

In this example, no other state is available to the instructions which operate to transform the operation space to a local section space for a specific operation to be performed. All operations performed by the instructions therefore operate on the boundary registers, including intermediate calculations.

Some sequences of instructions will transform one dimension at a time, starting with dimension 0 (e.g. b[0]) and work iteratively inwards through the dimensions. In other more complex sequences of instructions, more complex transforms may need to jump around by modifying the destination register identifier explicitly e.g. by using a SETD instruction in the set of instructions.

The result of executing the transform program for a specific block defines a block in section space, ready to be used for the invocation of the specific hardware execution unit that is to execute the section. In the case of many types of operation to be performed by a hardware execution unit to execute a section, the execution unit does not use a full 8-dimension section space. The handling unit therefore defines an invocation structure for each unit that defines the relevant requirements for that operation.

### Apparatus for Sending Command Messages

In examples herein, the apparatus (such as the apparatus 2 of FIG. 2 and/or the neural engine 700 of FIG. 5) is configurable to execute a task on behalf of a processor. In these examples, the apparatus comprises control interface circuitry configured to receive, from the processor, at least one command message to instruct execution of the task by the apparatus. A suitable apparatus for use in sending command messages such as this is shown in FIG. 7.

FIG. 7 schematically illustrates a data processing apparatus 1, which in FIG. 7 comprises a central processing unit (CPU) 4. The data processing apparatus 1 may be referred to as a processor. The CPU 4 may include one or more processor cores, although only one core is shown in FIG. 7.

The CPU 4 comprises processing circuitry 6 to execute data processing instructions defined in an instruction set architecture (ISA) to carry out data processing operations represented by the data processing instructions. The processing circuitry 6 performs operations on data loaded from a memory system, and may store the results back to the memory system. In this example the memory system includes a level one cache 10, a level two cache 20, and main memory 24, but it will be appreciated that this is just one example of a possible memory hierarchy and other implementations can have further levels of cache or a different arrangement. For example, separate level one caches 10 may be provided for instructions and data. The provision of caches 10, 20 within the CPU 4 enables faster access to data than from memory 24 (which can include on-chip and/or off-chip memory 24).

The CPU 4 also comprises a memory management unit 16 (MMU), to perform address translation in response to memory access instructions executed by the processing circuitry 6. The MMU 16 translates virtual addresses specified by memory access requests into physical addresses identifying storage locations of data in the memory system. The MMU 16 has a translation lookaside buffer (TLB) 18 for caching address translation data from page tables stored in the memory system, where the page table entries of the page tables define the address translation mappings and may also specify access permissions which govern whether a given process executing on the pipeline is allowed to read, write or execute instructions from a given memory region.

The data processing apparatus 1 also includes a hardware accelerator 22, which is an example of an apparatus as described in examples herein comprising a handling unit, storage and an execution unit, such as the apparatus 200 of FIG. 2 and/or the neural engine 700 of FIG. 5. The hardware accelerator 22 is configurable, based on an instruction generated by the processing circuitry 6, to perform a task. The task may be a delegated task, which is performed asynchronously by the hardware accelerator 22 with respect to operations performed by the processing circuitry 6. In FIG. 7, the hardware accelerator 22 is unique (private) to a single processor core 4, and therefore may be referred to as a core local accelerator (CLA). The hardware accelerator 22 is controlled by, and communicates with the memory system via, an associated processor core. The CPU 4 therefore comprises accelerator control interface circuitry 14 (a core local accelerator control module (CLAC)) to exchange messages, such as command messages and resource messages, with the hardware accelerator 22 to control the hardware accelerator 22. In this example, the messages exchanged between the accelerator control interface circuitry 14 and the hardware accelerator 22 each have a size less than or equal to a predefined size and are exchanged in this case via control circuitry 25 of the accelerator control interface circuitry 14. For example, a transaction (e.g. corresponding to a message) sent between the accelerator control interface circuitry 14 and the hardware accelerator 22 may be formed of up to eight words, each of up to eight bytes (B) in length. The accelerator control interface circuitry 14 and the hardware accelerator 22 in this example can thus exchange messages that each have a size of up to 64B in total.

The hardware accelerator 22 accesses the memory system via the CPU 4, and issues accelerator-triggered memory access requests using virtual addresses. In response to an accelerator-triggered memory access request received at the accelerator control interface circuitry 14 from the hardware accelerator 22, the MMU 16 translates a virtual address specified by the accelerator-triggered memory access request to a physical address of a memory system location to be accessed in response to the accelerator-triggered memory access request.

The processing circuitry 6 supports execution of accelerator control instructions in an ISA, separate from load/store instructions, for controlling the accelerator control interface circuitry 14 to perform functions such as launching accelerator commands, checking on accelerator status, reading internal accelerator state, writing other accelerator control registers, etc. In FIG. 7, the processing circuitry 6 is configured to generate an instruction for configuring the hardware accelerator 22, via the accelerator control interface circuitry 14, to perform a task. The instruction may be generated in response to execution of accelerator control instructions by the processing circuitry 6, and sent to the hardware accelerator 22 by the accelerator control interface circuitry 14.

However, in other examples, the CPU 4 may comprise memory-mapped register storage accessible in response to load/store instructions executed by the processing circuitry 6 specifying target addresses mapped to the memory-mapped register storage. Hence, accelerator commands may be triggered by execution of load/store instructions which specify addresses mapped to the memory-mapped register storage, illustrated in FIG. 7 as the “CLAC registers” 23. The CPU 4 (via the accelerator interface circuitry 14) may control operation of the hardware accelerator 22 by writing to and reading from the memory-mapped register storage. Hence, the processing circuitry 6 in these examples can control operation of a hardware accelerator 22 using conventional load/store instructions (with the address of the load/store instructions distinguishing accelerator control instructions from other load/store instructions targeting locations in the memory system 10, 20, 24). This may be the case where the CLAC registers 23 are sufficiently large to store the load/store instructions for configuring the hardware accelerator 22. In these examples, the load/store instructions may be considered to be or comprise an instruction generated by the processing circuitry 6 for configuring the hardware accelerator 22 to perform a task.

The CLAC registers 23 may comprise a LAUNCH register (not shown in FIG. 7). The processing circuitry 6 can cause accelerator control signals (such as command messages and/or resource messages) to be issued to a given hardware accelerator 22 by writing to the LAUNCH register. Writing different values to the LAUNCH register can be used to indicate that the processing circuitry 6 requests the hardware accelerator control interface circuitry 14 to initiate different operations for performance by the hardware accelerator 22.

In the example of FIG. 7, the CLAC registers 23 (e.g. the DATA registers of the CLAC registers 23) are not large enough to store an instruction for configuring the hardware accelerator 22 to perform a particular task. In FIG. 7, a storage size of the DATA registers is less than a bit-length of a predefined set of fields of the instruction. In this example, there are 8 DATA registers, each with a storage size of 64b for storing one message to be sent to the hardware accelerator 22, i.e. so that the total storage size of the DATA registers is 512b (64B). The CLAC registers 23 comprise the DATA registers in FIG. 7. The DATA registers allow a set of messages with a payload of up to 64B to be sent from the CLAC registers 23 to the hardware accelerator 22. In the example of FIG. 7, the packet header has a size of 64b, and the payload has a size of up to 64B, meaning that each set of messages allows up to 72B of data to be sent to the hardware accelerator 22. However, the bit-length of the predefined set of fields is larger than this in FIG. 7 and may be, for example, 640B or 320B. To address this, examples herein comprise identifying a selected set of fields of the predefined set of fields for sending to the hardware accelerator 22, so as to reduce the size of the data to be sent to the hardware accelerator 22 (and to be stored in the DATA registers). For example, the selected set of fields may have a bit-length greater than the predefined size of messages exchanged between the accelerator control interface circuitry 14 and the hardware accelerator 22 (i.e. a bit-length of greater than 8B in the example of FIG. 7). However, the selected set of fields may have a bit-length of less than or equal to the (combined) storage size of the DATA registers (i.e. a bit-length of less than or equal to 64B), so that each of the selected set of fields may be stored concurrently in the DATA registers.

In this example, the predefined set of fields comprise a control field indicative of the selected set of fields, which are sufficient to configure the hardware accelerator 22 to perform the task. At least one of the predefined set of fields may take a predefined value, such as a null value or 0. In these cases, the predefined value(s) need not be provided to the hardware accelerator 22 in order to configure the hardware accelerator 22 to perform the task, allowing a reduced amount of data to be sent to the hardware accelerator 22 than otherwise. the predefined set of fields of the instruction comprises a control field indicative of a selected set of fields of the predefined set of fields to be provided to the hardware accelerator 22 to configure the hardware accelerator 22 to perform the task. The selected set of fields may correspond to the fields of the predefined set of fields that comprise non-trivial values (e.g. values that differ from a predefined, null, 0 or otherwise default value). The selected set of fields may thus differ for different tasks, depending on the nature of the task. If the predefined set of fields comprises a first subset of fields, each having a non-zero value, and a second subset of fields, each having a zero value, the first subset of fields may be chosen as the selected set of fields, which are to be sent to the hardware accelerator 22. Sending of the second subset of fields (e.g. the non-selected set of fields) to the hardware accelerator 22 may be omitted without affecting performance of the task. The second subset of fields may for example be skipped in generating command message(s) for sending to the hardware accelerator 22 to configure the hardware accelerator 22 to perform the task.

The processing circuitry 6 determines how to distribute the selected set of fields across a set of command messages, which may be one or more command message. For example, the processing circuitry 6 may determine to include a first set of the selected set of fields in a first command message of the set of command messages, and a second set of the selected set of fields in a second command message of the set of command messages. A size of each of the command messages need not be the same (but may be). For example, a first size of the first command message may be different from a second size of the second command message, to provide greater flexibility.

In this example, the selected set of fields are sent to the hardware accelerator 22, for example by the accelerator control interface circuitry 14, using a set of command messages with a combined size greater than the predefined size. The combined size of the selected set of fields may be too large to send the selected set of fields as a single transaction so the selected set of fields may instead be sent using a set of command messages (e.g. using a plurality of transactions), each of which has a size less than or equal to the predefined size. In other examples, though, the accelerator control interface circuitry 14 may send a single command message comprising the selected set of fields. The set of command messages are then received by the hardware accelerator 22, e.g. by control interface circuitry, from the accelerator control interface circuitry 14. The hardware accelerator 22 obtains, from the set of command messages, a selected set of fields of a predefined set of fields of an instruction to configure the hardware accelerator to perform the task. The selected set of fields are those sent in the set of command messages by the processor, and for example represent non-zero values (or values that are otherwise not predefined, null or default values) indicative of the task to be performed by the hardware accelerator 22.

The selected set of fields comprise a control field indicative of which fields of the predefined set of fields are included in the selected set of fields. The instruction can then be reconstructed by the hardware accelerator 22 from the set of command messages, based on the control field, to obtain a reconstructed instruction. For example, as the control field indicates which fields of the predefined set of fields are included in the selected set of fields, the hardware accelerator 22 can determine which fields of the predefined set of fields are omitted from the fields sent in the set of command messages. To recreate the reconstructed instruction, the hardware accelerator 22 can then add these omitted fields back in, to re-generate the predefined set of fields (formed of the selected set of fields received in the set of command messages and the fields that the hardware accelerator 22 has determined, from the control field, were missing from the set of command messages). The hardware accelerator 22 may then assign predefined values to each of these so-called “missing” (or otherwise skipped or non-selected) fields of the reconstructed instruction. The predefined values are for example 0 or another null value but, in other cases, the predefined values may instead be another predefined non-zero value.

In this way, the hardware accelerator 22 can reconstruct the instruction from the set of command messages, without the instruction being sent in its entirety to the hardware accelerator 22. This allows the hardware accelerator 22 to be configured to perform the task more efficiently, for example with fewer transactions between the processor and the hardware accelerator 22, than otherwise. The set of fields obtained by the hardware accelerator 22 from the command messages (e.g. by a handling unit of the hardware accelerator 22) include a task-specific variable field comprising the task-specific variable data described in examples herein.

### Example Data Structures

FIG. 8 shows an example of a data structure 500 for storing an instruction for configuring the processor 630 (e.g. the apparatus 200 and/or the neural engine 700 of the processor 630) to perform a task, which in this example is a neural engine task comprising execution of a multi-dimensional nested loop over a plurality of dimensions. This task comprises processing of a portion of a multi-dimensional tensor, for example representing a portion of a feature map. In FIG. 8, the task comprises a loop over 4 dimensions (labelled 0, 1, 2, 3). The instruction defines a coordinate range within a multi-dimensional space corresponding to the portion of the multi-dimensional tensor that is to be processed. It is to be appreciated that the actual dimensionality of the task may be higher than 4. The predefined set of fields of the instruction comprise, for each respective dimension of a plurality of dimensions (in this case, for each of the 4 dimensions), lower and upper bound fields indicative of a lower and upper bounds of the coordinate range in the respective dimension.

In this example, the data structure 500 is separated into 8B words, divided into two rows of 4B each in FIG. 8. The data structure 500 comprises the following predefined set of fields:
a. a “params” field (bits [31:0] of row 0 and bits [7:0] of row 1);
b. a header field (bits [31:28] of row 1, which take predefined values of 0001 respectively);
c. a first “Reserved” field (bits [27:8] of row 1);
d. a “ned_pointer” field (bits [31:0] of rows 2 and 3);
e. a “trace_id” field (bits [31:8] of row 4 and bits [31:0] of row 5);
f. a “task_id” field (bits [7:0] of row 4);
g. an “nestat_pointer” field (bits [31:0] of rows 6 and 7);
h. a “task_seed” field (bits [31:0] of rows 8 and 9);
i. a second “Reserved” field (bits [31:0] of rows 10 to 15);
j. a “task_lower_bound_dimn” field for dimensions n=0, 1, 2, 3 (bits [31:0] of rows 16-17, 20-21, 24-25, 28-29 respectively);
k. a “task_upper_bound_dimn” field for dimensions n=0, 1, 2, 3 (bits [31:0] of rows 18-19, 22-23, 26-27, 30-31 respectively); and
l. “task_const_m” fields for constants m=0 to 7 (bits [31:0] of rows 32 to 39, respectively).

The “params” field corresponds to a control field indicative of a selected set of fields of the predefined set of fields to be provided to a hardware accelerator 22 to perform the task. The “params” field itself is included in the selected set of fields so as that the control field is provided to the hardware accelerator 22 to enable the hardware accelerator 22 to correctly reconstruct the instruction. The control field may take various forms. In the example of FIG. 8, the control field comprises a mask indicative of whether each 8B word is included in the selected set, on a per-word basis. In other examples, though, the control field comprises a mask indicative of whether each field is included the predefined set of fields is included in the selected set, on a per-field basis. Indicating whether each element is to be included in the selected set on a per-element (e.g. per-word or per-field) basis for example provides flexibility in the selection of data for the selected set, which may improve efficiency by reducing the sending of unnecessary data to a greater extent than less flexible approaches. A mask may be a compact and efficient way of signaling which of the fields are to be included in the selected set.

In this example, the mask is a bit-wise mask, comprising an element per word. As there are 20 words in the example of FIG. 8, the mask comprises 20 elements, each corresponding to a different respective word. In this case, the “params” field has a bit-length of 40 bits, so is capable of storing values of up to 40 elements but in other cases the bit-length of the “params” field may be equal to the number of fields in the predefined set of fields. A state of each of the elements can indicate, in a simple manner, whether the corresponding portion of the predefined set of fields (e.g. a corresponding word, set of words or field(s)) is to be included in the selected set. For example, if an element of the mask has a value of 0, this may indicate (and in FIG. 8 does indicate) that the corresponding word (and the field(s) stored in that word) is excluded from the selected set of fields and is thus to be omitted in a set of command messages to send to the hardware accelerator. Conversely, a non-zero value of an element of the mask, such as a value of 1, may indicate (and in FIG. 8 does indicate) that the corresponding word (and the field(s) stored in that word) is included in the selected set of fields and is thus to be provided to the hardware accelerator, via the set of command messages.

The predefined value of the header is used to indicate to the hardware accelerator 22 that this is the start of the instruction, and is thus typically included in the selected set of fields. The “Reserved” fields may be set aside for desired use as defined by the processing circuitry 6 and are typically not included in the selected set of fields. The “ned_pointer” field is an example of a task field indicative of a task descriptor defining at least one operation for performing the task. In this case, the “ned_pointer” field provides a pointer to the NED for the task, indicating a physical address of the NED in storage, such as storage of or accessible to the CPU 4 and/or the hardware accelerator 22. The “ned_pointer” field is typically included in the selected set of fields, so as to configure the hardware accelerator 22 to perform the task defined by the NED. The “trace_id”, “task_id” and “nestat_pointer” for example provide information for use by processing circuitry (such as that of the CPU 4 and/or the hardware accelerator 22) in keeping track of the processing performed, which may be used to aid in detecting and resolving processing errors or issues. At least one of the “trace_id”, “task_id” and “nestat_pointer” fields may be included in the selected set of fields in a development environment (for example for debug purposes) and skipped (e.g. not included in the selected set of fields) in a deployed environment in which the data structure 500 is deployed to perform the task. The “task_seed” field represents a seed value that can be used in randomized operations to perform the task, such as randomized or stochastic rounding. The seed value is typically non-zero, so the “task_seed” field will typically be included in the selected set of fields if random numbers are used in performing the task. However, the “task_seed” field may be omitted in some cases, such as for the performance of some tasks that do not involve the use of random numbers.

The “task_lower_bound_dimn” and “task_upper_bound_dimn” fields for a given dimension represent the lower and upper bounds of the coordinate range in that dimension.

The “task_const_m” fields are task-specific variable fields, each storing respective task-specific variable data. In this example, the “task_const_m” fields represent constant values (labelled using arbitrary labels m=0 to 7). The “task_const_m” fields represent the 8 possible task-specific variables that can be moved, based on the data move instruction, into a physical storage location, such as a portion of a boundary register 210 as described with reference to FIG. 2.

A task-specific variable may be used in processing for various reasons such as those described above with reference to FIGS. 1 and 2. For example, a task-specific variable represented by a “task_const_m” field can be used in applying a padding to a region of a tensor. For example, the task-specific variable may be used as a padding value, so that when an out-of-bounds region of a tensor is accessed, the out-of-bound coordinates are filled with the constant value, and/or a size and/or number of padding elements in applying the padding may be based on the task-specific variable. A task-specific variable, e.g. representing a constant value, can be used in standard vector operations, e.g. to subtract, multiply etc. a tensor with a constant value. A task-specific variable value can be used in the calculation of a dimension, e.g. to provide some striding or offsetting in a dimension while calculating dimensions of blocks within that dimension. It is to be appreciated that these uses of task-specific variable values, such as constant values, are non-limiting, and task-specific variable values and/or constant values may be used for various purposes.

It may be expected or anticipated that the certain fields will be utilized by the hardware accelerator 22 in executing the task, irrespective of the task itself. For example, typically the control field will be used by the hardware accelerator 22 to determine which of the fields of the predefined set of fields are received in the set of command messages. The task field, indicative of the task descriptor, will also typically be used by the hardware accelerator 22 to determine which task is to be performed. A header field, for example indicative of a start of an instruction to configure the hardware accelerator 22 may also be used by the hardware accelerator 22 to identify when a new instruction is received. The processing circuitry 6 may thus be configured to generate the instruction to indicate that a predefined selected set of fields (e.g. the control field, the header field and/or the task field) is comprised by the selected set of fields. The predefined selected set of fields are, for example, those fields that are typically sent to the hardware accelerator 22 independently of the nature of the task itself. By predefining these fields, the determination of which of the fields to include in the selected set of fields may be simplified.

The greater the number of fields that can be omitted from the selected set of fields to be sent to the hardware accelerator 22, via the set of command messages, the smaller the combined size of the set of command messages. Typically, at least some of the predefined set of fields can be omitted from the selected set of fields. For example, at least some of the predefined set of fields may tend to be zero (or another predefined, null or otherwise default value) for particular tasks, and may be excluded from the selected set of fields.

In some cases, a value of at least one of the predefined set of fields may be set to a predefined value, such as zero, in order to further reduce the number of fields included in the selected set of fields. In such cases, the setting of the value(s) to the predefined value may be compensated for elsewhere within a pipeline for performing the task, for example by adjusting another value to be sent to, or to be used by, the hardware accelerator 22.

### Simulator Implementation

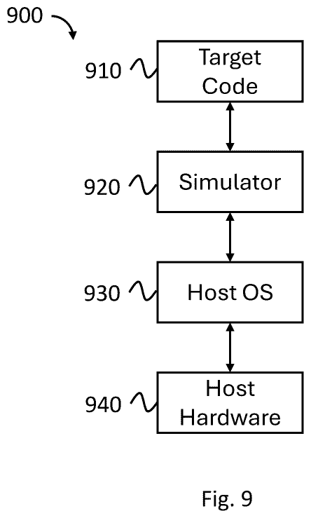

FIG. 9 illustrates a simulator implementation 900 that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 940, optionally running a host operating system 930, supporting the simulator program 920. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware or provide an instruction execution environment typically associated with a different hardware architecture. An overview of simulation is given in “Some Efficient Architecture Simulation Techniques,” Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 940), some simulated embodiments may make use of the host hardware, where suitable.

The simulator program 920 may be stored on a computer-readable storage medium (which may be a non-transitory medium), and provides a program interface (instruction execution environment) to the target code 910 which is the same as the application program interface of the hardware architecture being modelled by the simulator program 920. Thus, the pro. m instructions of the target code 910, including the control of memory accesses based on the realm protection functionality described above, may be executed from within the instruction execution environment using the simulator program 920, so that a host computer 940 which does not actually have the hardware features of the apparatus shown in FIG. 2, discussed above but can emulate these features.

The simulator program 920 is for example a computer program for controlling a host data processing apparatus to provide an instruction execution environment for execution of the target code 910 (which may be referred to as target program code). The simulator program 920 for example comprises data structure program logic for interacting with a data structure and processing program logic configured to implement methods according to examples herein.

### Programs and Systems for Implementing Examples Herein

Concepts described herein may be embodied in a system comprising at least one packaged chip. In some cases, the processor described earlier may be implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

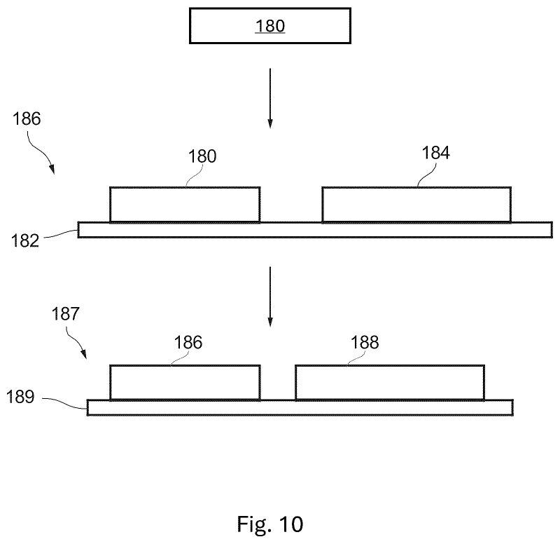

As shown in FIG. 10, one or more packaged chips 180, with the processor described above implemented on one chip or distributed over two or more of the chips, are manufactured by a semiconductor chip manufacturer. In some examples, the chip product 180 made by the semiconductor chip manufacturer may be provided as a semiconductor package which comprises a protective casing (e.g. made of metal, plastic, glass or ceramic) containing the semiconductor devices implementing the processor described above and/or connectors, such as lands, balls or pins, for connecting the semiconductor devices to an external environment. Where more than one chip 180 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 180 are assembled on a board 182 together with at least one system component 184 to provide a system 186. For example, the board may comprise a printed circuit board. The board substrate may be made of any of a variety of materials, e.g. plastic, glass, ceramic, or a flexible substrate material such as paper, plastic or textile material. The at least one system component 184 comprise one or more external components which are not part of the one or more packaged chip(s) 180. For example, the at least one system component 184 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 187 is manufactured comprising the system 186 (including the board 182, the one or more chips 180 and the at least one system component 184) and one or more product components 188. The product components 188 comprise one or more further components which are not part of the system 187. As a non-exhaustive list of examples, the one or more product components 188 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 187 and one or more product components 188 may be assembled on to a further board 189.

The board 182 or the further board 189 may be provided on or within a device housing or other structural support (e.g. a frame or blade) to provide a product which can be handled by a user and/or is intended for operational use by a person or company.

The system 186 or the chip-containing product 187 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

### Further Examples

At least some aspects of the examples described herein comprise computer processes performed in processing systems or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc.

The term processing element, processor, or processing unit (terms may be used interchangeably) has been used above to describe a hardware component that performs processing on data. The term encompasses, without limitation, central processing units (CPU), graphical processing units (GPU) and Neural Processing units/Tensor Processing units (NPU/TPU). Where the term CPU, GPU, NPU/TPU has been used this term may be generalized to the term processor.

In some implementations, the processor may comprise a chip. The chip (sometimes referred to as system on a chip SoC) may comprise multiple components, such as CPU, GPU, NPU and a storage component. In some implementations, the component may include circuits embedded on a single piece of material, such as a semiconductor wafer. As explained below, which circuits form part of each of the CPU, GPU, and NPU may be a matter of definition rather than inherent properties of the circuits.

The storage may be a unified storage that may be accessible by one, more, or all of the circuits on the chip. Allowing each circuit to access the same storage may improve the speed with which data can be processed.

Terms such as CPU, GPU and NPU are referred to in the art, but their meaning may depend on context. The CPU may be a ‘central’ or ‘main’ processing unit. However, in distributed systems or systems where there are multiple processing cores, the concept of a ‘main’ or ‘central’ processing unit may not be relevant. Further, while a GPU may be a hardware accelerator for graphics processing tasks, a GPU may sometimes be used for accelerating processing of neural networks. Further, there may be aspects of a graphics task that involve processing of neural networks. Accordingly, a GPU may be considered to be an NPU and vice versa depending on the context of the processing and/or intended primary purpose of the processor.

A typical feature of NPU and GPU designs is an ability to perform certain operations in parallel resulting in hardware acceleration. Correspondingly, a trend in CPU design has been the inclusion of an increased numbers of cores that increase the ability to process data in parallel. Accordingly, it is to be appreciated that parallel processing may be performed using various processor types.

One or more embodiments above may have been described in the context of one or more of a CPU, GPU, or NPU. For the avoidance of doubt, the techniques described herein may be applied more generally to a processor for the reasons given above.

In the preceding description, for purposes of explanation, numerous specific details of certain examples are set forth. Reference in the specification to “an example” or similar language means that a particular feature, structure, or characteristic described in connection with the example is included in at least that one example, but not necessarily in other examples.

Further examples are envisaged. For example, in FIGS. 7 and 8, the predefined set of fields of the instruction for a processor to configure an apparatus to perform a task comprise a control field, which is used to indicate a selected set of fields of the predefined set of fields for sending to the apparatus. In other examples, though, the instruction may not comprise a control field. In such cases, a set of fields of the instruction (such as the predefined set of fields of the instruction) may be sent from the processor to the apparatus, using one or more command messages. In these cases, the set of fields may comprise a task-specific variable field comprising the task-specific variable data.

It is to be understood that any feature described in relation to any one example may be used alone, or in combination with other features described, and may also be used in combination with one or more features of any other of the example, or any combination of any other of the examples. Furthermore, equivalents and modifications not described above may also be employed without departing from the scope of the disclosure, which is defined in the accompanying claims.

Further examples are set out in the following numbered clauses:
1. An apparatus comprising storage, an execution unit and a handling unit, wherein the handling unit is configured to:
   obtain task data that describes a task to be executed, the task comprising a plurality of operations representable as a directed graph of operations, the task data comprising task-specific variable data representative of a task-specific variable for use in executing an operation of the plurality of operations;
   obtain a data move instruction;
   based on the data move instruction, move the task-specific variable data into a physical storage location of the storage; and
   dispatch invocation data, based on the task data and the physical storage location, to the execution unit to cause the execution unit to execute the operation.
2. The apparatus of clause 1, wherein the invocation data comprises at least one of: the task-specific variable data; or a pointer to the physical storage location storing the task-specific variable data.
3. The apparatus of clause 1 or clause 2, wherein the task data defines a multi-dimensional nested loop defining an operation space, the handling unit is configured to iterate over the operation space in blocks, the storage comprises, for each dimension of the multi-dimensional nested loop, a respective boundary register for storing, for a given block of the blocks, range data defining a range of the given block in the respective dimension, and the physical storage location comprises at least a field of a particular boundary register of the boundary registers.
4. The apparatus of clause 3, wherein the boundary register for each respective dimension comprises:
   a low bound field for storing a low bound of the given block in the respective dimension; and
   a high bound field for storing a high bound of the given block in the respective dimension, and
   the physical storage location comprises at least one of the low bound field or the high bound field of the particular boundary register.
5. The apparatus of clause 4, wherein the handling unit is configured to, in dependence on a boundary register modifier associated with the data move instruction, at least one of:
   set a particular low bound field of the particular boundary register to a particular value and move the task-specific variable data to a particular high bound field of the particular boundary register; or move the task-specific variable data to the particular low bound field.
6. The apparatus of any one of clauses 3 to 5, wherein the handling unit is configured to set a value of the task-specific variable on a per-block basis for at least a plurality of the blocks.
7. The apparatus of any one of clauses 3 to 6, wherein, for at least one of the blocks, the handling unit is configured to modify the range data based on the task-specific variable, to modify a range of the at least one block in at least one dimension.
8. The apparatus of any one of clauses 1 to 7, wherein the task data defines a multi-dimensional nested loop defining an operation space, the handling unit is configured to iterate over the operation space in blocks, comprising mapping respective blocks in the operation space to different local blocks in an operation-specific local space, based on the task-specific variable data,
   wherein the invocation data for each respective block of the blocks specifies a local range of a local block, in the operation-specific local space, to be operated on for the respective block.
9. The apparatus of any one of clauses 1 to 8, wherein the task data comprises compiled task data compiled prior to setting a value of the task-specific variable.
10. The apparatus of any one of clauses 1 to 9, wherein the handling unit is configured to, after moving the task-specific variable data into the physical storage location, modify the task-specific variable data stored in the physical storage location based on the task data.
11. The apparatus of any one of clauses 1 to 10, comprising a plurality of execution units, comprising the execution unit, wherein each of the plurality of operations maps to a corresponding execution unit of the plurality of execution units.
12. The apparatus of any one of clauses 1 to 11, wherein the apparatus is configurable to execute the task on behalf of a processor and the apparatus comprises control interface circuitry configured to receive, from the processor, at least one command message to instruct execution of the task by the apparatus, and wherein the handling unit is configured to:
   obtain, from the at least one command message, a set of fields of an instruction to execute the task, the set of fields comprising a task-specific variable field comprising the task-specific variable data.
13. The apparatus of any one of clauses 1 to 12, wherein the operation comprises processing of an input feature map, and a padding to be applied to at least a portion of the input feature map in executing the operation is based on the task-specific variable.
14. The apparatus of any one of clauses 1 to 13, wherein the task-specific variable corresponds to a predetermined value to be used in response to an attempt to access an out-of-bounds value during execution of the operation.
15. The apparatus of any one of clauses 1 to 14, comprising:
   a core for executing the task, the core comprising the handling unit, the storage and the execution unit; and
   a further core for executing a further task of a job comprising the task and the further task, the further core comprising further storage, a further execution unit and a further handling unit configured to:
      obtain further task data that describes the further task, the further task data comprising further task-specific variable data representative of a further task-specific variable for use in executing a further operation;
      based on the data move instruction, move the further task-specific variable data into a further physical storage location of the further storage; and
      dispatch further invocation data, based on the further task data and the further physical storage location, to the further execution unit to cause the further execution unit to execute the further operation.
16. The apparatus of clause 15, wherein the task comprises applying the operation to a first portion of a tensor and the further task comprises applying the operation to a second portion of the tensor.
17. The apparatus of clause 16, wherein:
   the task data comprises reference data defining a reference portion of the tensor and the handling unit is configured to process the reference data based on the task-specific variable data to obtain first tensor data defining the first portion of the tensor; and
   the further task data comprises the reference data and the further handling unit is configured to process the reference data based on the further task-specific variable data to obtain second tensor data defining the second portion of the tensor.
18. A system comprising:
   the apparatus of any one of clauses 1 to 17, implemented in at least one packaged chip;
   at least one system component; and
   a board,
   wherein the at least one packaged chip and the at least one system component are assembled on the board.
19. A chip-containing product comprising the system of clause 18, wherein the system is assembled on a further board with at least one other product component.
20. A non-transitory computer-readable medium having stored thereon computer-readable code for fabrication of the apparatus of any one of clauses 1 to 17.
21. A method comprising:
   obtaining, by handling circuitry, task data that describes a task to be executed, the task comprising a plurality of operations representable as a directed graph of operations, the task data comprising task-specific variable data representative of a task-specific variable for use in executing an operation of the plurality of operations;
   obtaining, by the handling circuitry, a data move instruction;
   based on the data move instruction, the handling circuitry moving the task-specific variable data into a physical storage location of storage accessible to the handling circuitry; and
   dispatching, by the handling circuitry, invocation data, based on the task data and the physical storage location, to execution circuitry for execution of the operation.

What is claimed is:

1. An apparatus comprising storage, an execution unit and a handling unit, wherein the handling unit is configured to:
obtain task data that describes a task to be executed, the task comprising a plurality of operations representable as a directed graph of operations, the task data comprising task-specific variable data representative of a task-specific variable for use in executing an operation of the plurality of operations;
obtain a data move instruction;
based on the data move instruction, move the task-specific variable data into a physical storage location of the storage; and
dispatch invocation data, based on the task data and the physical storage location, to the execution unit to cause the execution unit to execute the operation.

2. The apparatus of claim 1, wherein the invocation data comprises at least one of: the task-specific variable data; or a pointer to the physical storage location storing the task-specific variable data.

3. The apparatus of claim 1, wherein the task data defines a multi-dimensional nested loop defining an operation space, the handling unit is configured to iterate over the operation space in blocks, the storage comprises, for each dimension of the multi-dimensional nested loop, a respective boundary register for storing, for a given block of the blocks, range data defining a range of the given block in the respective dimension, and the physical storage location comprises at least a field of a particular boundary register of the boundary registers.

4. The apparatus of claim 3, wherein the boundary register for each respective dimension comprises:
a low bound field for storing a low bound of the given block in the respective dimension; and
a high bound field for storing a high bound of the given block in the respective dimension, and
the physical storage location comprises at least one of the low bound field or the high bound field of the particular boundary register.

5. The apparatus of claim 4, wherein the handling unit is configured to, in dependence on a boundary register modifier associated with the data move instruction, at least one of:
set a particular low bound field of the particular boundary register to a particular value and move the task-specific variable data to a particular high bound field of the particular boundary register; or
move the task-specific variable data to the particular low bound field.

6. The apparatus of claim 3, wherein the handling unit is configured to set a value of the task-specific variable on a per-block basis for at least a plurality of the blocks.

7. The apparatus of claim 3, wherein, for at least one of the blocks, the handling unit is configured to modify the range data based on the task-specific variable, to modify a range of the at least one block in at least one dimension.

8. The apparatus of claim 1, wherein the task data defines a multi-dimensional nested loop defining an operation space, the handling unit is configured to iterate over the operation space in blocks, comprising mapping respective blocks in the operation space to different local blocks in an operation-specific local space, based on the task-specific variable data,
wherein the invocation data for each respective block of the blocks specifies a local range of a local block, in the operation-specific local space, to be operated on for the respective block.

9. The apparatus of claim 1, wherein the task data comprises compiled task data compiled prior to setting a value of the task-specific variable.

10. The apparatus of claim 1, wherein the handling unit is configured to, after moving the task-specific variable data into the physical storage location, modify the task-specific variable data stored in the physical storage location based on the task data.

11. The apparatus of claim 1, wherein the apparatus is configurable to execute the task on behalf of a processor and the apparatus comprises control interface circuitry configured to receive, from the processor, at least one command message to instruct execution of the task by the apparatus, and wherein the handling unit is configured to:
obtain, from the at least one command message, a set of fields of an instruction to execute the task, the set of fields comprising a task-specific variable field comprising the task-specific variable data.

12. The apparatus of claim 1, wherein the operation comprises processing of an input feature map, and a padding to be applied to at least a portion of the input feature map in executing the operation is based on the task-specific variable.

13. The apparatus of claim 1, wherein the task-specific variable corresponds to a predetermined value to be used in response to an attempt to access an out-of-bounds value during execution of the operation.

14. The apparatus of claim 1, comprising:
a core for executing the task, the core comprising the handling unit, the storage and the execution unit; and
a further core for executing a further task of a job comprising the task and the further task, the further core comprising further storage, a further execution unit and a further handling unit configured to:
obtain further task data that describes the further task, the further task data comprising further task-specific variable data representative of a further task-specific variable for use in executing a further operation;
based on the data move instruction, move the further task-specific variable data into a further physical storage location of the further storage; and
dispatch further invocation data, based on the further task data and the further physical storage location, to the further execution unit to cause the further execution unit to execute the further operation.

15. The apparatus of claim 14, wherein the task comprises applying the operation to a first portion of a tensor and the further task comprises applying the operation to a second portion of the tensor.

16. The apparatus of claim 15, wherein:
the task data comprises reference data defining a reference portion of the tensor and the handling unit is configured to process the reference data based on the task-specific variable data to obtain first tensor data defining the first portion of the tensor; and
the further task data comprises the reference data and the further handling unit is configured to process the reference data based on the further task-specific variable data to obtain second tensor data defining the second portion of the tensor.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A non-transitory computer-readable medium having stored thereon computer-readable code for fabrication of the apparatus of claim 1.

20. A method comprising:
obtaining, by handling circuitry, task data that describes a task to be executed, the task comprising a plurality of operations representable as a directed graph of operations, the task data comprising task-specific variable data representative of a task-specific variable for use in executing an operation of the plurality of operations;
obtaining, by the handling circuitry, a data move instruction;
based on the data move instruction, the handling circuitry moving the task-specific variable data into a physical storage location of storage accessible to the handling circuitry; and
dispatching, by the handling circuitry, invocation data, based on the task data and the physical storage location, to execution circuitry for execution of the operation.
